(19) United States
(12) Patent Application Publication
(10) Pub. No.: US 2019/0271885 A1
(43) Pub. Date: Sep. 5, 2019

(54) OPTICAL FILM AND METHOD FOR PRODUCING THE SAME, POLARIZING PLATE, AND IMAGE DISPLAY DEVICE

(71) Applicant: FUJIFILM Corporation, Tokyo (JP)

(72) Inventors: Keita TAKAHASHI, Minamiashigara-shi (JP); Nobuyuki AKUTAGAWA, Minamiashigara-shi (JP); Yoshiaki HISAKADO, Minamiashigara-shi (JP)

(73) Assignee: FUJIFILM Corporation, Tokyo (JP)

(21) Appl. No.: 16/419,811

(22) Filed: May 22, 2019

Related U.S. Application Data
(63) Continuation of application No. PCT/JP2017/044454, filed on Dec. 12, 2017.

(30) Foreign Application Priority Data
Dec. 28, 2016 (JP) 2016-255210

(51) Int. Cl. G02F 1/1337; G02F 1/1335; F21V 8/00; G02F 1/1334

(52) U.S. Cl. CPC G02F 1/133711; G02F 1/133528; G02F 2202/023; G02F 1/1334; G02B 6/0056

(57) ABSTRACT

An optical film has an alignment layer and a retardation layer which is disposed on the alignment layer and formed using a polymerizable liquid crystal composition including a predetermined liquid crystal compound, in which at least one of an acid having the pKa of −10.0 or less or a salt of the acid is included in at least one of the alignment layer or the retardation layer.

### CROSS-REFERENCE TO RELATED APPLICATIONS

This application is a Continuation of PCT International Application No. PCT/JP2017/044454 filed on Dec. 12, 2017, which claims priority under 35 U.S.C § 119(a) to Japanese Patent Application No. 2016-255210 filed on Dec. 28, 2016. Each of the above application(s) is hereby expressly incorporated by reference, in its entirety, into the present application.

### BACKGROUND OF THE INVENTION

### 1. Field of the Invention

The present invention relates to an optical film and a method for producing the same, a polarizing plate, and an image display device.

### 2. Description of the Related Art

A liquid crystal compound exhibiting reverse-wavelength dispersion properties enables, for example, conversion of an accurate light ray wavelength over a wide wavelength range and reduction in the thickness of a retardation layer due to a high refractive index.

In addition, as a design guideline for the liquid crystal compound exhibiting reverse-wavelength dispersion properties, a T-type molecular design guideline has been generally taken. More specifically, it has been required to decrease the wavelength of a long molecular axis while increasing the wavelength of a short axis positioned in the center of the molecule.

In this regard, it is known that a cycloalkylene skeleton having no absorption wavelength is used for the connection between a skeleton of the short axis positioned in the center of the molecule (hereinafter also referred to as a “reverse-wavelength dispersion expressing portion”) and the long molecular axis (see, for example, JP2011-207765A). Further, in the liquid crystal compound exhibiting reverse-wavelength dispersion properties used in the section of Examples of JP2011-207765A, the reverse-wavelength dispersion expressing portion and the cycloalkylene skeleton are bonded to each other via an ester group.

### SUMMARY OF THE INVENTION

The present inventors have studied an optical film including a retardation layer formed using a polymerizable liquid crystal composition including the liquid crystal compound described in JP2011-207765A, and thus, they have clarified that optical characteristics are deteriorated in a wet heat environment. Specifically, the present inventors have clarified that the in-plane retardation of the optical film is significantly deteriorated in a wet heat environment, and thus, the wet heat resistance is deteriorated.

Therefore, the present invention has an object to provide an optical film including a retardation layer, which has excellent wet heat resistance.

In addition, the present invention has another object to provide a method for producing the optical film, a polarizing plate, and an image display device.

The present inventors have conducted extensive studies on the objects, and as a result, they have found that a desired effect is obtained by incorporating an acid having a predetermined pKa and/or a salt thereof into at least one of an alignment layer or a retardation layer, thereby completing the present invention.

That is, the present inventors have found that the objects can be accomplished by the following configurations.

(1) An optical film comprising:

an alignment layer; and

a retardation layer which is disposed on the alignment layer and formed using a polymerizable liquid crystal composition including a liquid crystal compound represented by Formula (I) which will be described later,

in which at least one of an acid having the pKa of −10.0 or less or a salt of the acid is included in at least one of the alignment layer or the retardation layer.

(2) The optical film as described in (1),

in which at least one of D¹ or D² is *1-O—CO—, *1-O—CR¹R²—, or *1-O—CO—CR¹R²—, and *1 represents a bonding position on the Ar side.

(3) The optical film as described in (2),

in which in a case where D¹ is *1-O—CO—, *1-O—CR¹R²—, or *1-O—CO—CR¹R²—, a difference between the pKa of a compound represented by Formula (III) having the same structure as a partial structure represented by —O—Ar-D²-G²-D⁴-A²-SP²-L² in Formula (I) and the pKa of the acid is 18.0 or more.

HO—Ar-D²-G²-D⁴-A²-SP²-L² Formula (III)

(4) The optical film as described in (2),

in which in a case where both of D¹ and D² are *1-O—CO—, *1-O—CR¹R²—, or *1-O—CO—CR¹R²—, a difference between the pKa of a compound represented by Formula (II) having the same structure of a partial structure represented by —O—Ar—O— in Formula (I) and the pKa of the acid is 18.0 or more.

HO—Ar—OH Formula (II)

(5) The optical film as described in (3) or (4),

in which the difference is 21.0 or more.

(6) The optical film as described in (3) or (5),

in which the pKa of the compound represented by Formula (III) is 8.0 or more.

(7) The optical film as described in (6),

in which the pKa of the compound represented by Formula (III) is 8.3 or more.

(8) The optical film as described in (4) or (5),

in which the pKa of the compound represented by Formula (II) is 8.0 or more.

(9) The optical film as described in (8),

in which the pKa of the compound represented by Formula (II) is 8.3 or more.

(10) The optical film as described in any one of (1) to (9),

in which at least one of the acid or a salt of the acid is included in the alignment layer, and a total content of the acid and the salt of the acid in the alignment layer is 0.10% to 5.00% by mole with respect to the liquid crystal compound represented by Formula (I).

(11) The optical film as described in any one of (1) to (9),

in which at least one of the acid or a salt of the acid is included in the retardation layer, and a total content of the acid and the salt of the acid in the retardation layer is 0.10% to 5.00% by mole with respect to the liquid crystal compound represented by Formula (I).

(12) A polarizing plate comprising:

the optical film as described in any one of (1) to (11); and

a polarizer.

(13) An image display device comprising:

the optical film as described in any one of (1) to (11); or

the polarizing plate as described in (12).

(14) A method for producing the optical film as described in any one of (1) to (10), comprising:

applying a composition for forming an alignment layer, including a thermal acid generator that generates an acid having the pKa of −10.0 or less and a compound having a photoalignable group to form a coating film, subjecting the coating film to a heating treatment, and subjecting the coating film which has been subjected to the heating treatment to a photoalignment treatment to obtain the alignment layer; and

applying the polymerizable liquid crystal composition onto the alignment layer to form a coating film, subjecting the coating film to a heating treatment to align the liquid crystal compound, and subjecting the coating film to a curing treatment to obtain the retardation layer.

(15) A method for producing the optical film as described in any one of (1) to (9), and (11), comprising:

applying a polymerizable liquid crystal composition including the liquid crystal compound represented by Formula (I) and a thermal acid generator that generates an acid having the pKa of −10.0 or less onto an alignment layer to form a coating film, subjecting the coating film to a heating treatment to align the liquid crystal compound, and subjecting the coating film to a curing treatment to obtain the retardation layer.

According to the present invention, it is possible to provide an optical film including a retardation layer, which has excellent wet heat resistance.

In addition, according to the present invention, it is also possible to provide a method for producing the optical film, a polarizing plate, and an image display device.

### BRIEF DESCRIPTION OF THE DRAWINGS

FIG. 1 is a schematic cross-sectional view showing a first embodiment of an optical film.

FIG. 2 is a schematic cross-sectional view showing a second embodiment of the optical film.

### DESCRIPTION OF THE PREFERRED EMBODIMENTS

Hereinafter, the present invention will be described in detail.

The following description of the constitutional requirements is made based on representative embodiments of the present invention in some cases, but it should not be construed that the present invention is limited to such embodiments.

Furthermore, in the present specification, a numerical range expressed using “to” means a range that includes the preceding and succeeding numerical values of “to” as the lower limit value and the upper limit value, respectively.

In the present specification, Re(λ) and Rth(λ) each represent an in-plane retardation and a retardation in the thickness direction at a wavelength of λ. Unless otherwise specified, the wavelength of λ is intended to mean 550 nm.

In the present invention, Re(λ) and Rth(λ) are values measured at a wavelength of λ using AxoScan OPMF-1 (manufactured by Opto Science, Inc.). By inputting an average refractive index ((Nx+Ny+Nz)/3) and the film thickness (d (μm)) to AxoScan, it is possible to calculate:

Slow axis direction (°)

Re(λ)═R0(λ)

Rth(λ)=((nx+ny)/2−nz)×d.

In addition, R0(λ) is represented as a numerical value calculated by AxoScan OPMF-1, but means Re(λ).

In the present specification, as the refractive index nx, ny, or nz, an Abbe refractometer (NAR-4T, manufactured by Atago Co., Ltd.) is used and measured using a sodium lamp (λ=589 nm) as a light source. Further, in a case where wavelength dependence is measured, it can be measured in combination with an interference filter using a multi-wavelength Abbe refractometer DR-M2 (manufactured by Atago Co., Ltd.).

Moreover, values in Polymer Handbook (JOHN WILEY & SONS, INC), and catalogs of various optical films can be used. Values of an average refractive index for main optical films are exemplified as follows: cellulose acylate (1.48), cycloolefin polymer (1.52), polycarbonate (1.59), polymethyl methacrylate (1.49), and polystyrene (1.59).

Furthermore, the bonding direction of a divalent group (for example, —O—CO—) denoted in the present specification is not particularly limited, and for example, in a case where D¹ in Formula (I) which will be described later is —O—CO—, a bonding position on the Ar side is represented by *1, and a bonding position on the G¹ side is represented by *2, D¹ may be either *1-O—CO-*2 or *1-CO—O-*2.

One of the characteristics of the optical film of an embodiment of the present invention is that at least one of an acid having a predetermined pKa (hereinafter also simply referred to as a “specific acid”) or a salt of the specific acid is included in at least one of the alignment layer or the retardation layer.

The present inventors have conducted extensive studies on problems in the related art, and have thus found that deterioration of the wet heat resistance of a retardation layer in the related art is caused by easy decomposition of an ester group in a liquid crystal compound exhibiting reverse-wavelength dispersion properties, used for the formation of a retardation layer. For example, as described above, a reverse-wavelength dispersion expressing portion and a cycloalkylene skeleton in the liquid crystal compound exhibiting reverse-wavelength dispersion properties, specifically disclosed in JP2011-207765A, are bonded through an ester group. This ester group easily decomposes in a wet heat environment, and as a result, the wet heat resistance of the retardation layer is deteriorated.

In contrast, the present inventors have newly found that in a case where the retardation layer in a wet heat environment is in an acidic environment, decomposition of an ester group in a liquid crystal compound exhibiting reverse-wavelength dispersion properties hardly proceeds.

For example, in a case where at least one of a specific acid or a salt of the specific acid is included in a retardation layer, decomposition of the ester group is suppressed.

In addition, components included in each of the layers easily migrate in a wet heat environment. As a result, usually, even in a case where at least one of a specific acid or a salt of the specific acid is included in an alignment layer disposed adjacent to the retardation layer, at least one of a specific acid or a salt of the specific acid included in the alignment layer easily migrates into the retardation layer in the wet heat environment, and thus, the retardation layer is in an acidic environment, whereby decomposition of an ester group derived from the liquid crystal compound included in the retardation layer is suppressed.

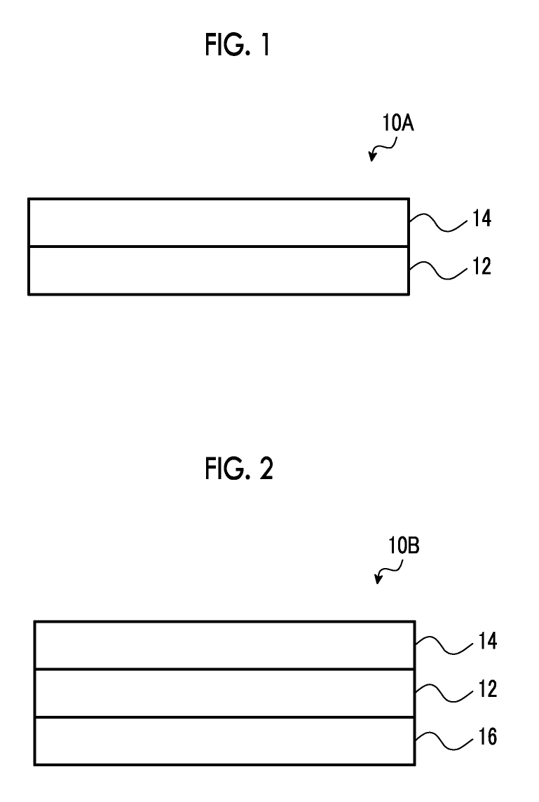

Hereinafter, the optical film of the embodiment of the present invention will be described with reference to drawings. FIG. 1 shows a cross-sectional view showing a first embodiment of the optical film. Further, the drawings in the present invention are schematic views, and the thickness relationship, the positional relationship, and the like of each of the layers do not necessarily match actual ones, which is also applied to the following drawing.

FIG. 1 is a schematic cross-sectional view showing the first embodiment of the optical film of the present invention. In FIG. 1, an optical film 10A includes an alignment layer 12 and a retardation layer 14 disposed adjacent to the alignment layer 12.

Hereinafter, each of members and materials included in the optical film will be described in detail.

First, the specific acid and a salt thereof included in the optical film will be described in detail.

At least one of the specific acid or a salt of the specific acid is included in at least one of the alignment layer or the retardation layer. Specifically, at least one of a specific acid or a salt of the specific acid may be included in only one of the alignment layer and the retardation layer, or at least one of the specific acid or a salt of the specific acid may be included in both of the alignment layer and the retardation layer. One or both of the specific acid and a salt thereof may be included in one of the respective layers or may be included in each of the layers.

Moreover, a presence or content of the specific acid and a salt thereof included in the alignment layer and the retardation layer can be measured by using time-of-flight secondary ion mass spectrometry (TOF-SIMS). Further, as described in detail in later paragraphs, the amounts of the specific acid and a salt thereof included in the alignment layer and the retardation layer can also be calculated from the amounts of the specific acid or a salt thereof, and an acid generator that generates the specific acid, which are used.

In a case where at least one of the specific acid or a salt of the specific acid is included in the alignment layer, the total content of the specific acid and a salt thereof in the alignment layer is not particularly limited, but from the viewpoint that the wet heat resistance of the optical film is more excellent, the total content is preferably 0.10% to 5.00% by mole, and more preferably 0.20% to 2.50% by mole, with respect to the liquid crystal compound represented by Formula (I) used for the formation of the retardation layer. Further, a specific amount of the total content of the specific acid and a salt thereof is preferably 0.25 to 12.3 nmol/cm² in the alignment layer.

Furthermore, in a case where at least one of the specific acid or a salt of the specific acid is included in the retardation layer, the total content of the specific acid and a salt thereof in the retardation layer is not particularly limited, but from the viewpoint that the wet heat resistance of the optical film is more excellent, the total content is preferably 0.10% to 5.00% by mole, and more preferably 0.20% to 2.50% by mole, with respect to the liquid crystal compound represented by Formula (I) used for the formation of the retardation layer. In addition, the specific amount of the total content of the specific acid and a salt thereof in the retardation layer is preferably 0.25 to 12.3 nmol/cm².

Moreover, for example, in a case where only the specific acid is included and a salt of the specific acid is not included in the alignment layer, the total content is calculated, considering the content of a salt of the specific acid in the alignment layer as 0.

The specific acid is an acid having the pKa of −10.0 or less.

The pKa of the specific acid is any value of −10.0 or less, and from the viewpoint that the wet heat resistance of the optical film is more excellent, the pKa is preferably −11.0 or less, and more preferably −12.0 or less. The lower limit is not particularly limited, but from the viewpoint that the wet heat resistance of the optical film is more excellent, the lower limit is preferably −20.0 or more, and more preferably −18.0 or more.

A salt of the specific acid is a compound in which one or more hydrogen ions included in the specific acid are substituted with cations such as metal ions and ammonium ions. The salt may be either a so-called inorganic or an organic salt.

The type of the metal ion is not particularly limited, and examples of the metal ion include an ion of a metal selected from the group consisting of an alkali metal and an alkaline earth metal.

Examples of the ammonium ion include NH₄⁺ and N(R)₄⁺ (R represents a hydrocarbon group).

The pKa is an acid dissociation constant, and a smaller value thereof indicates a higher acid strength.

In the present specification, the pKa is calculated based on the following procedures (i) to (iv). That is, in a case where the pKa of the specific acid can be calculated in (i), the pKa calculated with (i) is taken as the pKa of the specific acid. In a case where the pKa cannot be calculated with (i), a trial of calculation of the pKa is made with (ii), and in a case where the pKa can be calculated with (ii), the value is taken as the pKa of the specific acid. In addition, in a case where the pKa cannot be calculated with (ii), a trial of calculation of the pKa is made with (iii), and in a case where the pKa can be calculated with (iii), the value is taken as the pKa of the specific acid. Further, in a case where the pKa cannot be calculated with (iii), a trial of calculation of the pKa is made with (iv), and in a case where the pKa can be calculated with (iv), the value is taken as the pKa of the specific acid.

(i) The pKa value based on a Hammett substituent constant and the database of values in a well-known document is determined by computation using the following software package 1.

(Software Package 1)

Advanced Chemistry Development (ACD/Labs) Software V8.14 for Solaris (1994-2007 ACD/Labs).

As the pKa of a superacid which is computable with the software package 1, a value obtained by rounding off the second number after the decimal point of the original value is used.

(ii) For a superacid which is not computable with the software package 1 (a hypervalent compound including a boron atom, a phosphorus atom, or the like which is not computable due to a problem in programs), the pKa (DCE) described in Table 1 of Document 1 (J. Org. Chem., 2011, 76,391) is incorporated herein by reference. Here, DCM means the pKa in 1,2-dichloroethane as a solvent.

(iii) For a superacid which is not described in Document 1, the pKa is calculated using a conversion factor with reference to “Fluoride ion affinity of the Lewis Acid [kJ/mol]” described in Table 3 of Document 2 (Angew. Chem. Int. Ed., 2004, 43, 2066).

That is, the pKa is calculated by multiplying the pKa (−10.3) of “HBF₄” described in both of Document 1 and Document 2 and a conversion factor (−10.3/338) derived from a proportional calculation of Fluoride ion affinity of the Lewis Acid (338) by the value of the Fluoride ion affinity of the Lewis Acid of each component described in Document 2. For example, in a view that the value of the Fluoride ion affinity of the Lewis Acid of [PF₆]⁻ in Table 3 of Document 2 is 394, the pKa of HPF₆ can be calculated as follows: 394×(−10.3/338)=−12.0.

(iv) For a superacid which cannot be calculated with (i) to (iii) or a compound which is not described in Document 1 and Document 2, the value thereof is defined as a value equivalent to that of a compound having a similar structure in the present invention. Further, examples of the specific acid applied to the present calculation method include a specific acid X represented by HPFₙR₍₆₋ₙ₎ (R's each independently represent a perfluoroalkyl group and n represents an integer of 1 to 5). As the pKa of the specific acid X, the same pKa as HPF₆ in which R is substituted with a fluorine atom (F) is used. Specifically, the pKa of “HPF₆” or a partly alkyl-substituted group thereof, that is, “HP(C₂F₅)₃F₃” described in JP2012-246456A is handled as the same pKa (−12.0) as “HPF₆” in the present invention.

Examples of the pKa value of an acid calculated by the above-mentioned procedure are shown in Table 1 below.

TABLE 1

| | | pKa of | Calculation |
|---|---|---|---|
| Number | Type of acid | acid | method |
| 1 | 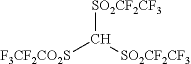 | −16.4 | (ii) |
| 2 | HSbF₆ | −14.9 | (iii) |
| 3 | 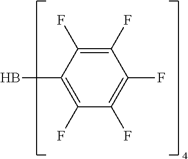 | −13.5 | (iii) |
| 4 | HP(C₂F₅)₃F₃ | −12 | (iv) |
| 5 | HPF₆ | −12 | (iii) |
| 6 | 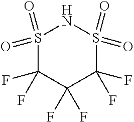 [SMILES: O=S1(=O)NS(=O)(=O)C(F)(F)C(F)(F)C1(F)F] | −11.6 | (i) |
| 7 | 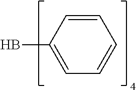 | −10.4 | (iii) |
| 8 | 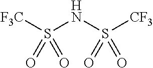 [SMILES: O=S(=O)(NS(=O)(=O)C(F)(F)F)C(F)(F)F] | −10.4 | (i) |
| 9 | HBF₄ | −10.3 | (ii) |
| 10 | C₄F₉—SO₃H | −3.6 | (i) |
| 11 | CF₃—SO₃H | −3.9 | (i) |
| 12 | 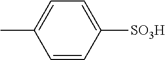 | −0.4 | (i) |

A type of the specific acid is not particularly limited and may be any types of acids representing the above-mentioned pKa. Among the acids, from the viewpoint that the handling properties are excellent and the wet heat resistance of the optical film is more excellent, examples of the acid include compounds represented by Formula (A) to Formula (E), and HSbF₆.

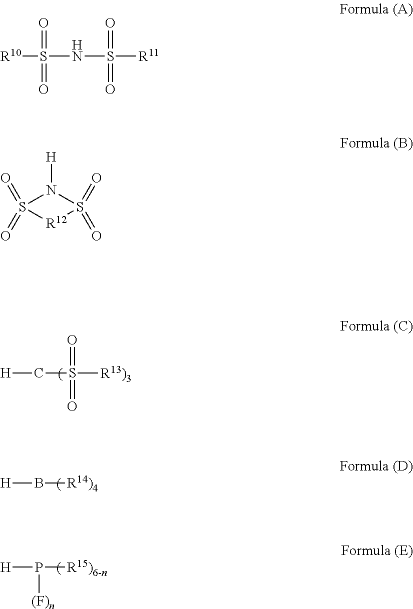

In Formula (A), R¹⁰ and R¹¹ each independently represent a perfluoroalkyl group. The number of carbon atoms in the perfluoroalkyl group is not particularly limited, but is preferably 1 to 10, and more preferably 1 to 5.

In Formula (B), R¹² represents a perfluoroalkylene group. The number of carbon atoms in the perfluoroalkylene group is not particularly limited, but is preferably 2 to 10, and more preferably 3 to 5.

In Formula (C), R¹³'s each independently represent a perfluoroalkyl group. The number of carbon atoms in the perfluoroalkyl group is not particularly limited, but is preferably 1 to 10, and more preferably 2 to 5.

In Formula (D), R¹⁴'s each independently represent a fluorine atom or an aryl group which may have a substituent. Examples of the aryl group include a phenyl group and a naphthyl group. The type of the substituent is not particularly limited, but examples thereof include an alkyl group and a halogen atom (preferably a fluorine atom).

In Formula (E), R¹⁵'s each independently represent a perfluoroalkyl group. The number of carbon atoms in the perfluoroalkyl group is not particularly limited, but is preferably 1 to 10, and more preferably 1 to 5.

n represents an integer of 1 to 6. Among those, n is preferably an integer of 3 to 6, and more preferably 6.

A method for incorporating at least one of a specific acid or a salt thereof into the alignment layer and the retardation layer is not particularly limited, but examples thereof include a method of forming an alignment layer using a composition for forming an alignment layer, including a specific acid or a salt thereof, a method of forming an alignment layer using a composition for forming an alignment layer, including an acid generator that generates a specific acid (for example, a thermal acid generator and a photoacid generator), a method of forming a retardation layer using a polymerizable liquid crystal composition including a specific acid or a salt thereof, and a method of forming a retardation layer using a polymerizable liquid crystal composition including an acid generator that generates a specific acid (for example, a thermal acid generator and a photoacid generator), which will be described in detail in paragraphs below.

Details thereof will be described in detail in paragraphs below.

<Alignment Layer>

The alignment layer is a layer for adjusting alignment properties of the components included in the retardation layer.

As described above, at least one of the specific acid or a salt thereof may be included in the alignment layer in some cases.

The thickness of the alignment layer is not particularly limited, but from the viewpoints of reduction in the thickness of an optical film and alignment control properties of the retardation layer, the thickness is preferably 0.01 to 10 μm, more preferably 0.01 to 5.0 μm, and still more preferably 0.01 to 2.0 μm.

A material constituting the alignment layer is not particularly limited, but is preferably a polymer. The polymer for the alignment layer is described in a number of documents and a number of commercially available products can be available.

For example, as the polymer, a polyvinyl alcohol or a polyimide, and derivatives thereof are preferable. Among those, a modified or non-modified polyvinyl alcohol is more preferable.

A method for forming the alignment layer is not particularly limited, and a known method may be mentioned. Examples of the method include a method in which a composition for forming an alignment layer is applied onto a substrate to form a coating film and the coating film is subjected to a rubbing treatment to form an alignment layer.

Furthermore, a so-called photoalignment layer may be used as the alignment layer. The type of the photoalignment layer is not particularly limited, and a known photoalignment layer can be used.

A material for forming the photoalignment layer is not particularly limited, but a compound having a photoalignable group is usually used. The compound may be a polymer having a repeating unit containing a photoalignable group.

The photoalignable group is a functional group capable of imparting anisotropy to a film by light irradiation. More specifically, the photoalignable group is a group having a change in a molecular structure thereof that can be caused upon irradiation with light (for example, linearly polarized light). Typically, the photoalignable group is a group which causes at least one photoreaction selected from a photoisomerization reaction, a photodimerization reaction, or a photolysis reaction upon irradiation with light (for example, linearly polarized light).

Among these photoalignable groups, a group which causes a photoisomerization reaction (a group having a structure to be photoisomerized) and a group which causes a photodimerization reaction (a group having a structure to be photodimerized) are preferable, and a group which causes a photodimerization reaction is more preferable.

The photoisomerization reaction refers to a reaction which causes steric isomerization or structural isomerization by action of light. As a material which causes such the photoisomerization reaction, a material having an azobenzene structure (K. Ichimura et al., Mol. Cryst. Liq. Cryst., 298, page 221 (1997)), a material having a hydrazono-3-ketoester structure (S. Yamamura et al., Liquid Crystals, Vol. 13, No. 2, page 189 (1993)), a material having a stilbene structure (J. G. Victor and J. M. Torkelson, Macromolecules, 20, page 2241 (1987)), and a material having a spiropyran structure (K. Ichimura et al., Chemistry Letters, page 1063 (1992); K. Ichimura et al., Thin Solid Films, Vol. 235, page 101 (1993)); and the like are known.

As the group which causes the photoisomerization reaction, a group including a C═C bond or a N═N bond, which causes a photoisomerization reaction, is preferable, and examples of such the group include a group having an azobenzene structure (skeleton), a group having a hydrazono-β-ketoester structure (skeleton) group, a group having a stilbene structure (skeleton), and a group having a spiropyran structure (skeleton).

The photodimerization reaction refers to a reaction in which an addition reaction occurs between two groups by the action of light, and typically, a ring structure is formed. As a material which causes the photodimerization, a material having a cinnamic acid structure (M. Schadt et al., J. Appl. Phys., Vol. 31, No. 7, page 2155 (1992)), a material having a coumarin structure (M. Schadt et al., Nature., Vol. 381, page 212 (1996)), a material having a chalcone structure (Toshihiro Ogawa et al., Preprints of Symposium on Liquid Crystals, 2AB03 (1997)), and a material having a benzophenone structure (Y K. Jang et al., SID Int. Symposium Digest, P-53 (1997)) are known.

Examples of the group which causes the photodimerization reaction include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamic acid structure and a group having a coumarin structure are preferable and a group having a cinnamic acid structure is more preferable.

Furthermore, the compound having a photoalignable group may further have a crosslinkable group. As the crosslinkable group, a thermally crosslinkable group which causes a curing reaction by the action of heat is preferable.

Examples of the crosslinkable group include an epoxy group, an oxetanyl group, a group represented by —NH—CH₂—O—R (R represents at least one selected from the group consisting of a hydrogen atom or an alkyl group having 1 to 20 carbon atoms), an ethylenically unsaturated group, and a block isocyanate group. Among those, the epoxy group and/or the oxetanyl group is preferable.

In addition, a cyclic ether group with a 3-membered ring is also referred to as an epoxy group, and a cyclic ether group with a 4-membered ring is also referred to as an oxetanyl group.

As one of suitable aspects of the alignment layer, an alignment layer (photoalignment layer) formed using a composition for forming an alignment layer (composition for forming a photoalignment layer) including a polymer A having a constitutional unit a1 containing a cinnamate group and a low-molecular-weight compound B having a cinnamate group having a smaller molecular weight than the polymer A may be mentioned. Incidentally, the “constitutional unit” has the same definition as the “repeating unit”.

Here, In the present specification, the cinnamate group is a group having a cinnamic acid structure including cinnamic acid or a derivative thereof as a basic skeleton, and refers to a group represented by Formula (I′) or Formula (II′).

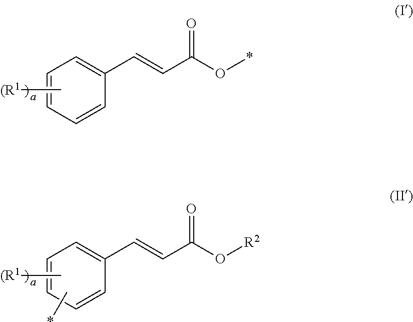

In the formulae, R¹ represents a hydrogen atom or a monovalent organic group, and R² represents a monovalent organic group. In Formula (I′), a represents an integer of 0 to 5, and in Formula (II′), a represents 0 to 4. In a case where a is 2 or more, a plurality of R¹'s may be the same as or different from each other. * represents a bonding arm.

The polymer A is not particularly limited as long as it is a polymer having a constitutional unit a1 containing a cinnamate group, and a polymer known in the related art can be used.

The weight-average molecular weight of the polymer A is preferably 1,000 to 500,000, and more preferably 2,000 to 300,000, and still more preferably 3,000 to 200,000.

Here, the weight-average molecular weight is defined as a value in terms of polystyrene (PS) by measurement with gel permeation chromatography (GPC), and the measurement by GPC in the present invention can be performed using HLC-8220GPC (manufactured by Tosoh Corp.) and TSKgel Super HZM-H, HZ4000, or HZ2000 as a column.

Examples of the constitutional unit a1 containing a cinnamate group contained in the polymer A include repeating units represented by Formulae (A1) to (A4).

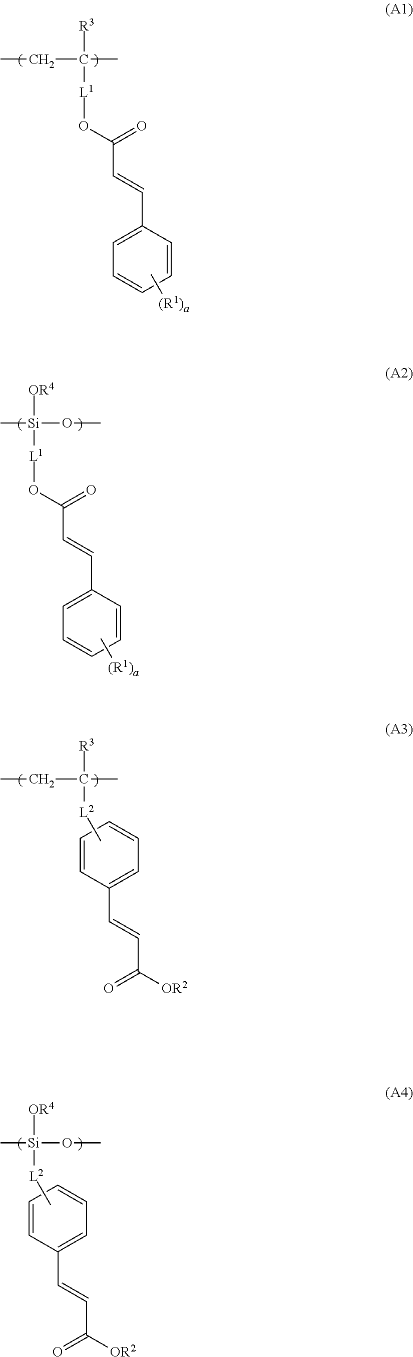

Here, in Formula (A1) and Formula (A3), R³ represents a hydrogen atom or a methyl group, and in Formula (A2) and Formula (A4), R⁴ represents an alkyl group having 1 to 6 carbon atoms.

In Formula (A1) and Formula (A2), L¹ represents a single bond or a divalent linking group, a represents an integer of 0 to 5, and R¹ represents a hydrogen atom or a monovalent organic group.

In Formula (A3) and Formula (A4), L² represents a divalent linking group, and R² represents a monovalent organic group.

In addition, specific examples of L¹ include —CO—O-Ph-, —CO—O-Ph-Ph-, —CO—O—(CH₂)ₙ—, —CO—O—(CH₂)ₙ-Cy-, and —(CH₂)ₙ-Cy-. Here, Ph represents a divalent benzene ring (for example, a phenylene group) which may have a substituent, Cy represents a divalent cyclohexane ring (for example, a cyclohexane-1,4-diyl group) which may have a substituent, and n represents an integer of 1 to 4.

Furthermore, specific examples of L² include —O—CO— and —O—CO—(CH₂)m-O—. Here, m represents an integer of 1 to 6.

Moreover, examples of the monovalent organic group of R¹ include a chained or cyclic alkyl group having 1 to 20 carbon atoms, an alkoxy group having 1 to 20 carbon atoms, and an aryl group having 6 to 20 carbon atoms which may have a substituent.

Furthermore, examples of the monovalent organic group of R² include a chained or cyclic alkyl group having 1 to 20 carbon atoms, and an aryl group having 6 to 20 carbon atoms which may have a substituent.

Moreover, it is preferable that a is 1, and it is preferable that R¹ is positioned at the para-position.

In addition, examples of the substituent which may be contained in a Ph, Cy, or the aryl group include an alkyl group, an alkoxy group, a hydroxy group, a carboxy group, and an amino group.

From the viewpoints that the alignment properties of the retardation layer are further improved and the adhesiveness of the retardation layer is further improved, it is preferable that the polymer A further has a constitutional unit a2 containing a crosslinkable group.

A definition and suitable aspects of the crosslinkable group are as described above.

Among those, as the constitutional unit a2 containing a crosslinkable group, a constitutional unit having an epoxy group and/or an oxetanyl group is preferable.

Specific preferred examples of the constitutional unit having an epoxy group and/or an oxetanyl group include the following constitutional units. Further, R³ and R⁴ each have same definitions as R³ and R⁴, respectively, in Formula (A1) and Formula (A2).

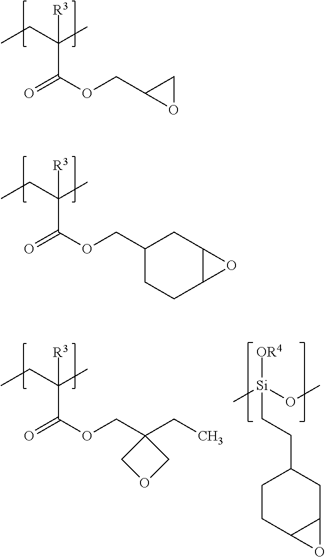

The polymer A may have a constitutional unit other than the constitutional unit a1 and the constitutional unit a2 as described above.

Examples of a monomer forming such other constitutional units include an acrylic acid ester compound, a methacrylic acid ester compound, a maleimide compound, an acrylamide compound, an acrylonitrile, a maleic acid anhydride, a styrene compound, and a vinyl compound.

The content of the polymer A in the composition for forming an alignment layer is preferably 0.1 to 50 parts by mass, and more preferably 0.5 to 10 parts by mass, with respect to 100 parts by mass of the solvent, in a case where an organic solvent which will be described later is included.

The low-molecular-weight compound B is a compound which has a cinnamate group and a smaller molecular weight than the polymer A. By using the low-molecular-weight compound B, the alignment properties of an alignment layer manufactured is improved.

For a reason that the alignment properties of the photoalignment layer are further improved, the molecular weight of the low-molecular-weight compound B is preferably 200 to 500, and more preferably 200 to 400.

Examples of the low-molecular-weight compound B include a compound represented by Formula (B 1).

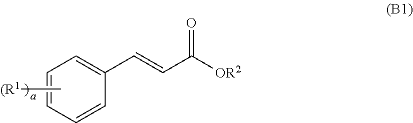

In Formula (B1), a represents an integer of 0 to 5, R¹ represents a hydrogen atom or a monovalent organic group, and R² represents a monovalent organic group. In a case where a is 2 or more, a plurality of R¹'s may be the same as or different from each other.

Furthermore, examples of the monovalent organic group of R¹ include a chained or cyclic alkyl group having 1 to 20 carbon atoms, an alkoxy group having 1 to 20 carbon atoms, and an aryl group having 6 to 20 carbon atoms which may have a substituent, and among these, the alkoxy group having 1 to 20 carbon atoms is preferable, an alkoxy group having 1 to 6 carbon atoms is more preferable, and a methoxy group or an ethoxy group is still more preferable.

Furthermore, examples of the monovalent organic group of R² include a chained or cyclic alkyl group having 1 to 20 carbon atoms and an aryl group having 6 to 20 carbon atoms which may have a substituent, and among these, a chained alkyl group having 1 to 20 carbon atoms is preferable, and a branched alkyl group having 1 to 10 carbon atoms is more preferable.

Moreover, it is preferable that a is 1, and it is preferable that R¹ is positioned at the para-position.

In addition, examples of the substituent of the above-mentioned aryl group include an alkyl group, an alkoxy group, a hydroxy group, a carboxy group, and an amino group.

The content of the low-molecular-weight compound B in the composition for forming an alignment layer is preferably 10 to 500% by mass, and more preferably 30 to 300% by mass, with respect to the mass of the constitutional unit a1 of the polymer A.

For a reason that the alignment properties of the composition for forming an alignment layer are further improved, it is preferable that a crosslinking agent C having a crosslinkable group is further included, in addition to the polymer A having the constitutional unit a2 containing a crosslinkable group.

The molecular weight of the crosslinking agent C is preferably 1,000 or less, and more preferably 100 to 500.

Examples of the crosslinking agent C include a compound having two or more epoxy groups or oxetanyl groups within a molecule thereof, a block isocyanate compound (compound having a protected isocyanate group), and an alkoxymethyl group-containing compound.

Among those, the compound having two or more epoxy groups or oxetanyl groups within a molecule thereof or the block isocyanate compound is preferable.

In a case where the composition for forming an alignment layer includes the crosslinking agent C, the content of the crosslinking agent C is preferably 1 to 1,000 parts by mass, and more preferably 10 to 500 parts by mass, with respect to 100 parts by mass of the constitutional unit a1 of the polymer A.

It is preferable that the composition for forming an alignment layer includes a solvent from the viewpoint of workability for forming an alignment layer. Examples of the solvent include water and an organic solvent.

Specific examples of the organic solvent include ketones (for example, acetone, 2-butanone, methyl isobutyl ketone, cyclohexanone, and cyclopentanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), alcohols (for example, ethanol, isopropanol, butanol, and cyclohexanol), cellosolves (for example, methyl cellosolve and ethyl cellosolve), cellosolve acetates, sulfoxides (for example, dimethylsulfoxide), and amides (for example, dimethylformamide and dimethylacetamide), and these may be used alone or in combination of two or more kinds thereof.

The composition for forming an alignment layer may include components other than the above components, and examples of such other components include a crosslinking catalyst, an adhesion improver, a leveling agent, a surfactant, and a plasticizer.

<Retardation Layer>

The retardation layer is a layer formed using a polymerizable liquid crystal composition including a liquid crystal compound represented by Formula (I) which will be described later, which has an optically anisotropic layer having in-plane retardation.

Furthermore, the retardation layer exhibits reverse-wavelength dispersion properties (characteristics of in-plane retardation which equals or increases as a measurement wavelength increases).

The value of the in-plane retardation of the retardation layer is not particularly limited, and is adjusted to be in an optimal range according to applications of the optical film.

For example, the retardation layer may be a so-called λ/2 plate. The λ/2 plate refers to an optically anisotropic layer in which an in-plane retardation Re(λ) at a specific wavelength of λ nm satisfies Re(λ)≈λ/2. This formula only needs to be satisfied at any one wavelength (for example, 550 nm) in a visible light range. More specifically, the in-plane retardation Re(550) at a wavelength of 550 nm is preferably 200 to 400 nm, and more preferably 240 to 320 nm.

Furthermore, the retardation layer may also be a so-called λ/4 plate. The λ/4 plate is a plate having a function of converting linearly polarized light at a specific wavelength to circularly polarized light (or converting circularly polarized light to linearly polarized light). More specifically, it is a plate having an in-plane retardation at a predetermined wavelength of λ nm exhibiting λ/4 (or an odd multiple thereof). More specifically, the in-plane retardation Re(550) at a wavelength of 550 nm is preferably 100 to 200 nm, and more preferably 120 to 160 nm.

The thickness of the retardation layer is not particularly limited, but is preferably 0.1 to 10 μm, and more preferably 0.5 to 5 μm.

The retardation layer is formed using a polymerizable liquid crystal composition including a liquid crystal compound represented by Formula (I).

L¹-SP¹-A¹-D³-G-D-Ar-D²-G²-D⁴-A²-SP²-L² Formula (I)

In Formula (I), D¹, D², D³, and D⁴ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—.

Here, at least one of D¹, D², D³, or D⁴ represents —O—CO—. Among those, in a case where D¹ and D² both represent —O—CO—, the effect of the present invention is more significant.

R¹, R², R³, and R⁴ each independently represent a hydrogen atom, a fluorine atom, or an alkyl group having 1 to 4 carbon atoms.

Furthermore, in Formula (I), G¹ and G² each independently represent a divalent alicyclic hydrocarbon group having 5 to 8 carbon atoms which may have a substituent, and one or more of —CH₂-'s constituting the alicyclic hydrocarbon group may be substituted with —O—, —S—, or —NH—.

Moreover, in Formula (I), A¹ and A² each independently represent a single bond, an aromatic ring having 6 or more carbon atoms, or a cycloalkylene ring having 6 or more carbon atoms.

Furthermore, in Formula (I), SP¹ and SP² each independently represent a single bond, a linear or branched alkylene group having 1 to 14 carbon atoms, or a divalent linking group in which one or more of —CH₂-'s constituting the linear or branched alkylene group having 1 to 14 carbon atoms are substituted with —O—, —S—, —NH—, —N(Q)-, or —CO—, and Q represents a polymerizable group.

In addition, in Formula (I), L¹ and L² each independently represent a monovalent organic group, and at least one of L or L² represents a polymerizable group, provided that in a case where Ar is an aromatic ring represented by Formula (Ar-3), at least one of L¹ or L², or L³ or L⁴ in Formula (Ar-3) represents a polymerizable group.

In Formula (I), as a divalent alicyclic hydrocarbon group represented by each of G¹ and G², a 5- or 6-membered ring having 5 to 8 carbon atoms is preferable. Further, the alicyclic hydrocarbon group may be either a saturated alicyclic hydrocarbon group or an unsaturated alicyclic hydrocarbon group, and is preferably a saturated alicyclic hydrocarbon group. With regard to the divalent alicyclic hydrocarbon group represented by each of G¹ and G², reference can be made to the description in paragraph 0078 of JP2012-021068A, the contents of which are incorporated herein by reference.

In Formula (I), examples of the aromatic ring having 6 or more carbon atoms, represented by each of A¹ and A², include aromatic hydrocarbon rings such as a benzene ring, a naphthalene ring, an anthracene ring, and a phenanthroline ring; and aromatic heterocyclic rings such as a furan ring, a pyrrole ring, a thiophene ring, a pyridine ring, a thiazole ring, and a benzothiazole ring. Among those, the benzene ring (for example, a 1,4-phenyl group) is preferable.

Furthermore, in Formula (I), examples of the cycloalkylene ring having 6 or more carbon atoms, represented by each of A¹ and A², include a cyclohexane ring and a cyclohexene ring, and among these, the cyclohexane ring (for example, a cyclohexane-1,4-diyl group) is preferable.

In Formula (I), as the linear or branched alkylene group having 1 to 14 carbon atoms, represented by each of SP¹ and SP², for example, a methylene group, an ethylene group, a propylene group, and a butylene group are preferable.

In Formula (I), the polymerizable group represented by at least one of L¹ or L² is not particularly limited, but is preferably a radically polymerizable group (group capable of radical polymerization) or a cationically polymerizable group (group capable of cationic polymerization).

A known radically polymerizable group can be used as the radically polymerizable group, and an acryloyl group or a methacryloyl group is preferable. In this case, it is generally known that the acryloyl group exhibits a fast polymerization rate, and thus, the acryloyl group is preferable from the viewpoint of improvement of productivity, but the methacryloyl group can also be used as the polymerizable group of a highly birefringent liquid crystal.

A known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among those, the alicyclic ether group or the vinyloxy group is preferable, and the epoxy group, the oxetanyl group, or the vinyloxy group is more preferable.

Particularly preferred examples of the polymerizable groups include the following ones. Further, * in the following polymerizable groups represents a bonding position.

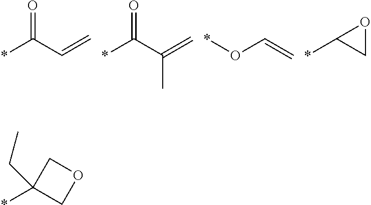

On the other hand, in Formula (I), Ar represents any one aromatic ring selected from the group consisting of groups represented by Formulae (Ar-1) to (Ar-5). Further, in Formulae (Ar-1) to (Ar-5), *1 represents a bonding position to D¹ and *2 represents a bonding position to D²

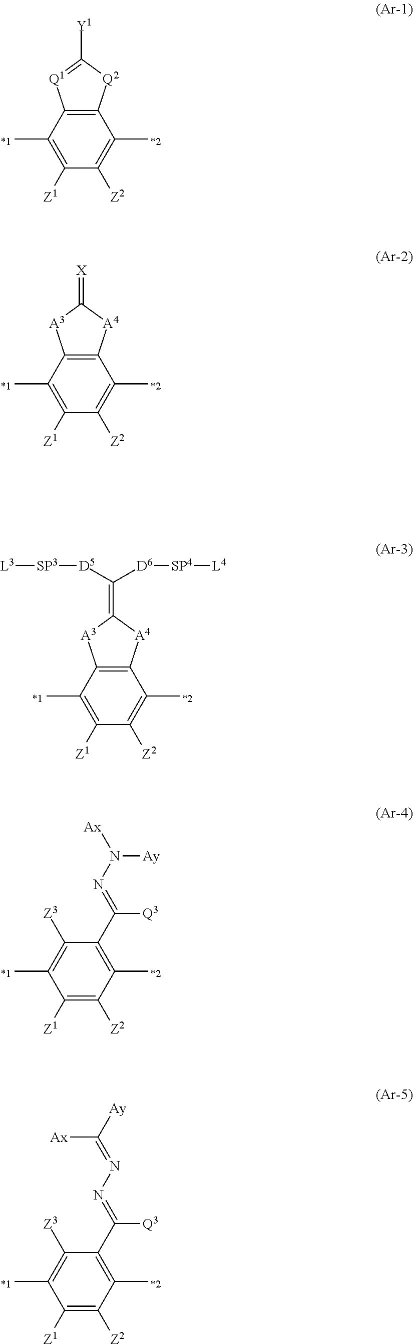

Here, in Formula (Ar-1), Q¹ represents N or CH, Q² represents —S—, —O—, or —N(R⁵)—, R⁵ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, which may have a substituent.

Specific examples of the alkyl group having 1 to 6 carbon atoms represented by R⁵ include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms represented by Y¹ include aryl groups such as a phenyl group, a 2,6-diethylphenyl group, and a naphthyl group.

Examples of the aromatic heterocyclic group having 3 to 12 carbon atoms represented by Y¹ include heteroaryl groups such as a thienyl group, a thiazolyl group, a furyl group, a pyridyl group, and a benzofuryl group. Further, examples of the aromatic heterocyclic group include a group formed by fusion of a benzene ring and an aromatic heterocyclic ring.

Furthermore, examples of the substituent which may be contained in Y¹ include an alkyl group, an alkoxy group, a nitro group, an alkylsulfonyl group, an alkyloxycarbonyl group, a cyano group, and a halogen atom.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and a methyl group or an ethyl group is particularly preferable.

As the alkoxy group, for example, an alkoxy group having 1 to 18 carbon atoms is preferable, an alkoxy group having 1 to 8 carbon atoms (for example, a methoxy group, an ethoxy group, an n-butoxy group, and a methoxyethoxy group) is more preferable, an alkoxy group having 1 to 4 carbon atoms is still more preferable, and a methoxy group or an ethoxy group is particularly preferable.

Examples of the halogen atom include a fluorine atom, a chlorine atom, a bromine atom, and an iodine atom, and the halogen atom is preferably a fluorine atom or a chlorine atom.

Furthermore, in Formula (Ar-1) to (Ar-5), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —NR⁶R⁷, or —SR, R⁶ to R⁸ each independently represent a hydrogen atom or an alkyl group having 1 to 6 carbon atoms, and Z¹ and Z² may be bonded to each other to form a ring. The ring may be any one of an alicycle, a heterocyclic ring, or an aromatic ring, and is preferably an aromatic ring. Further, a ring thus formed may be substituted with a substituent.

As the monovalent aliphatic hydrocarbon group having 1 to 20 carbon atoms, an alkyl group having 1 to 15 carbon atoms is preferable, an alkyl group having 1 to 8 carbon atoms is more preferable, a methyl group, an ethyl group, an isopropyl group, a tert-pentyl group (1,1-dimethylpropyl group), a tert-butyl group, or a 1,1-dimethyl-3,3-dimethyl-butyl group is still more preferable, and a methyl group, an ethyl group, or a tert-butyl group is particularly preferable.

Examples of the monovalent alicyclic hydrocarbon group having 3 to 20 carbon atoms include monocyclic saturated hydrocarbon group such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene group; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and the fluorine atom, the chlorine atom, or the bromine atom is preferable.

On the other hand, specific examples of the alkyl group having 1 to 6 carbon atoms, represented by each of R⁶ to R⁸, include a methyl group, an ethyl group, a propyl group, an isopropyl group, an n-butyl group, an isobutyl group, a sec-butyl group, a tert-butyl group, an n-pentyl group, and an n-hexyl group.

Furthermore, in Formulae (Ar-2) and (Ar-3), A³ and A⁴ each independently represent a group selected from the group consisting of —O—, —N(R⁹)—, —S—, and —CO—, and R⁹ represents a hydrogen atom or a substituent.

Examples of the substituent represented by R⁹ include the same ones as the substituent which may be contained in Y¹ in Formula (Ar-1).

Furthermore, in Formula (Ar-2), X represents a hydrogen atom or a non-metal atom of Groups 14 to 16 to which a substituent may be bonded.

Moreover, examples of the non-metal atom of Groups 14 to 16 represented by X include an oxygen atom, a sulfur atom, a nitrogen atom having a substituent, and a carbon atom having a substituent, and examples of the substituent include the same ones as the substituent which may be contained in Y¹ in Formula (Ar-1).

Moreover, in Formula (Ar-3), D⁵ and D⁶ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Moreover, in Formula (Ar-3), SP³ and SP⁴ each independently represent a single bond, a linear or branched alkylene group having 1 to 12 carbon atoms, or a divalent linking group in which one or more of —CH₂-'s constituting the linear or branched alkylene group having 1 to 12 carbon atoms are substituted with —O—, —S—, —NH—, —N(Q)-, or —CO—, and Q represents a polymerizable group.

Furthermore, in Formula (Ar-3), L³ and L⁴ each independently represent a monovalent organic group, and at least one of L³, L⁴, or L¹ or L² in Formula (I) represents a polymerizable group.

Moreover, in Formulae (Ar-4) to (Ar-5), Ax represents an organic group having 2 to 30 carbon atoms, which has at least one aromatic ring selected from the group consisting of an aromatic hydrocarbon ring and an aromatic heterocyclic ring.

Furthermore, in Formulae (Ar-4) to (Ar-5), Ay represents a hydrogen atom, an alkyl group having 1 to 6 carbon atoms which may have a substituent, or an organic group having 2 to 30 carbon atoms, which has at least one aromatic ring selected from the group consisting of an aromatic hydrocarbon ring and an aromatic heterocyclic ring.

Here, the aromatic rings in each of Ax and Ay may have a substituent, and Ax and Ay may be bonded to each other to form a ring.

In addition, Q³ represents a hydrogen atom or an alkyl group having 1 to 6 carbon atoms which may have a substituent.

Examples of Ax and Ay include ones described in paragraphs 0039 to 0095 of WO2014/010325A.

Incidentally, examples of the alkyl group having 1 to 6 carbon atoms represented by Q³ include a methyl group, an ethyl group, a propyl group, an isopropyl group, an n-butyl group, an isobutyl group, a sec-butyl group, a tert-butyl group, an n-pentyl group, and an n-hexyl group. Examples of the substituent include the same ones as the substituents which may be contained in Y¹ in Formula (Ar-1).

Examples of the liquid crystal compound represented by Formula (I) are shown below. Further, the 1,4-cyclohexylene groups in the following formulae are all trans-1,4-cyclohexylene groups.

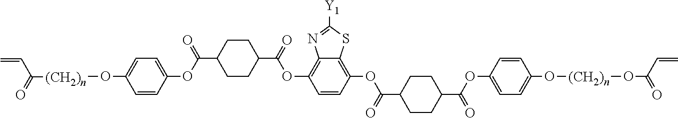

| No | Y1 | n |
|---|---|---|
| II-1-1 | 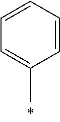 | 6 |
| II-1-2 | 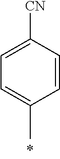 | 6 |
| II-1-3 | 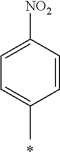 | 6 |
| II-1-4 | 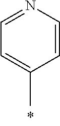 | 6 |
| II-1-5 | 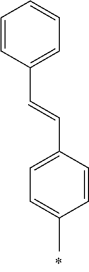 | 6 |
| II-1-6 | 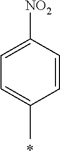 | 11 |
| II-1-7 | 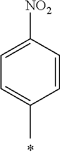 | 8 |
| II-1-8 | 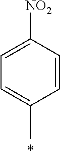 | 4 |
| II-1-9 | 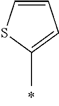 | 6 |
| II-1-10 | 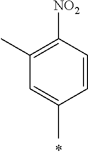 | 6 |
| II-1-11 | 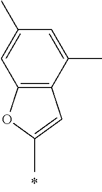 | 6 |
| II-1-12 | 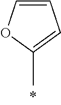 | 6 |
| II-1-13 | 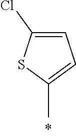 | 6 |
| II-1-14 | 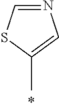 | 6 |
| II-1-15 | 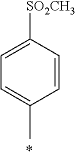 | 6 |

| | |
|---|---|
| II-1-16 | 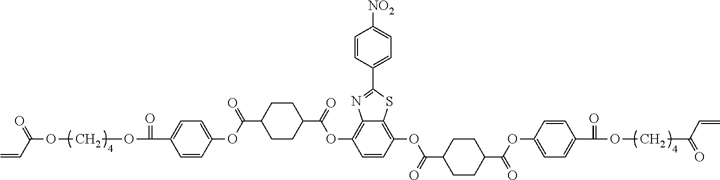 |
| II-1-17 | 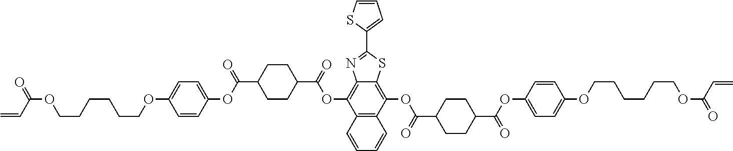 [SMILES: C=CC(=O)OCCCCCCOc1ccc(OC(=O)C2CCC(C(=O)Oc3c4ccccc4c(OC(=O)C4CCC(C(=O)Oc5ccc(OCCCCCCOC(=O)C=C)cc5)CC4)c4sc(-c5cccs5)nc34)CC2)cc1] |
| II-1-18 | 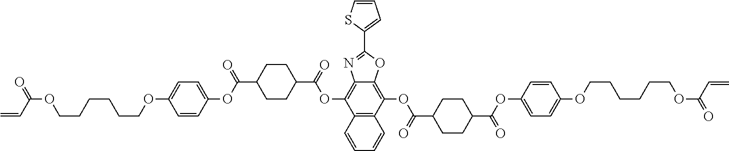 [SMILES: C=CC(=O)OCCCCCCOc1ccc(OC(=O)C2CCC(C(=O)Oc3c4ccccc4c(OC(=O)C4CCC(C(=O)Oc5ccc(OCCCCCCOC(=O)C=C)cc5)CC4)c4oc(-c5cccs5)nc34)CC2)cc1] |

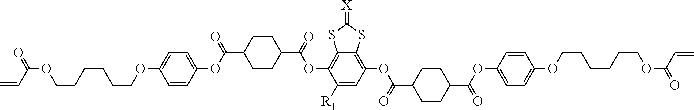

| No | X | R1 |
|---|---|---|
| II-2-1 | 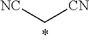 | H |
| II-2-2 | 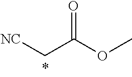 | H |
| II-2-3 | 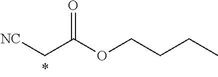 | H |
| II-2-4 | 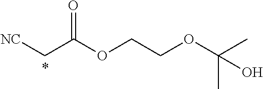 | H |
| II-2-5 | 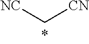 | CH₃ |
| II-2-6 | 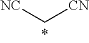 | 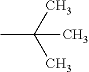 |
| II-2-7 | S | H |

Furthermore, in the formula, “*” represents a bonding position

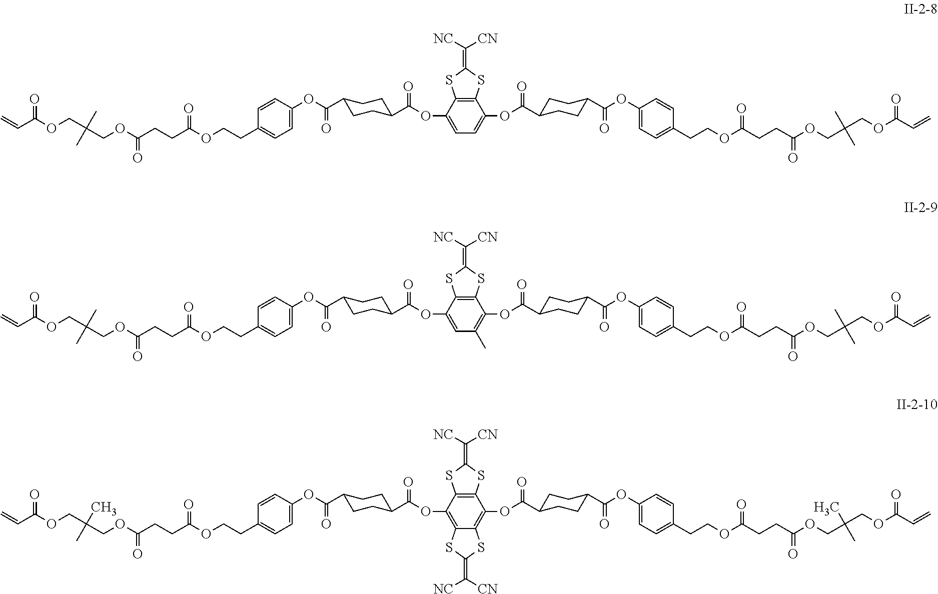

Moreover, a group adjacent to the acryloyloxy group in each of in Formulae II-2-8 and II-2-9 represents a propylene group (a group formed by substitution of a methyl group with an ethylene group), and represents a mixture of position isomers having different positions of methyl groups.

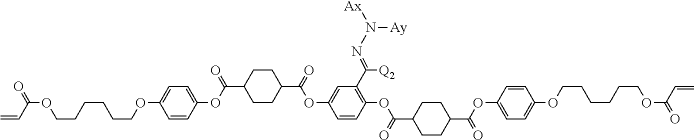

| No | Ax | Ay | Q2 |
|---|---|---|---|
| II-3-1 | 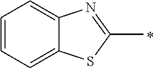 | H | H |
| II-3-2 | 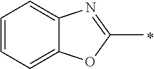 | H | H |
| II-3-3 | 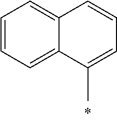 | H | H |
| II-3-4 | Ph | Ph | H |
| II-3-5 | 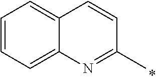 | H | H |
| II-3-6 | 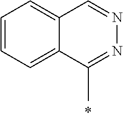 | H | H |
| II-3-7 | 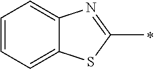 | CH₃ | H |
| II-3-8 | 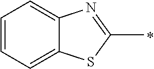 | C₄H₉ | H |
| II-3-9 | 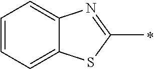 | C₆H₁₃ | H |
| II-3-10 | 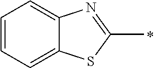 | 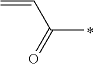 | H |
| II-3-11 | 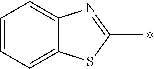 | 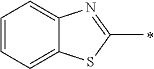 | H |
| II-3-12 | 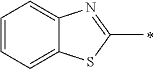 | CH₂CN | H |
| II-3-13 | 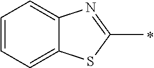 | 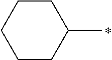 | H |
| II-3-14 | 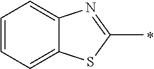 | 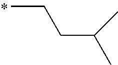 | H |
| II-3-15 | 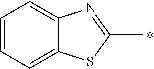 | CH₂CH₂OH | H |
| II-3-16 | 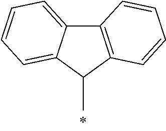 | H | H |
| II-3-17 | 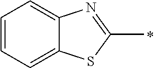 | CH₂CF₃ | H |
| II-3-18 | 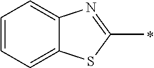 | H | CH₃ |
| II-3-19 | 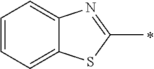 | 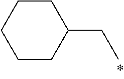 | H |
| II-3-20 | 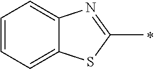 | 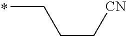 | H |
| II-3-21 | 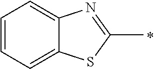 | 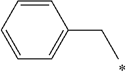 | H |
| II-3-22 | 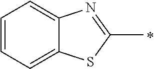 | 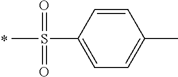 | H |
| II-3-23 | 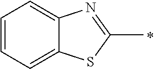 | 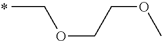 | H |
| II-3-24 | 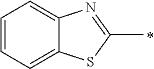 | 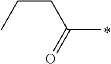 | H |
| II-3-25 | 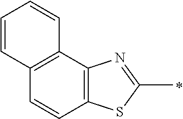 | C₆H₁₂ | H |

| | |
|---|---|
| II-3-26 | 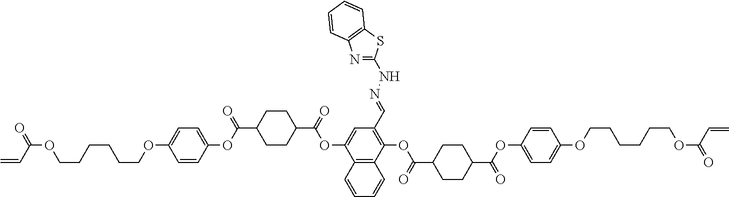 [SMILES: C=CC(=O)OCCCCCCOc1ccc(OC(=O)C2CCC(C(=O)Oc3cc(/C=N/Nc4nc5ccccc5s4)c(OC(=O)C4CCC(C(=O)Oc5ccc(OCCCCCCOC(=O)C=C)cc5)CC4)c4ccccc34)CC2)cc1] |
| II-3-27 | 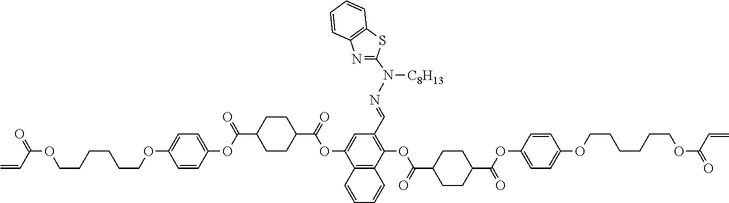 |

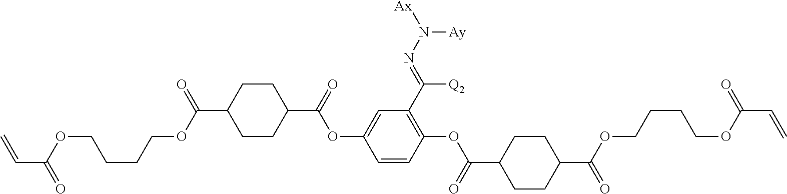

| No | Ax | Ay | Q2 |
|---|---|---|---|
| II-3-30 | 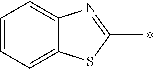 | H | H |
| II-3-31 | 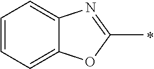 | H | H |
| II-3-32 | 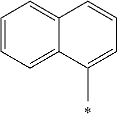 | H | H |
| II-3-33 | Ph | Ph | H |
| II-3-34 | 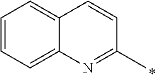 | H | H |
| II-3-35 | 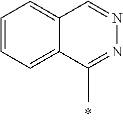 | H | H |
| II-3-36 | 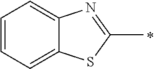 | CH₃ | H |
| II-3-37 | 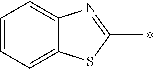 | C₄H₉ | H |
| II-3-38 | 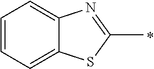 | C₈H₁₀ | H |
| II-3-39 | 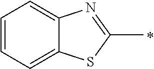 | 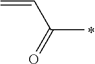 | H |
| II-3-40 | 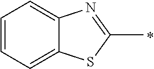 | 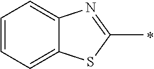 | H |
| II-3-41 | 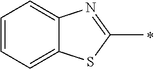 | CH₂CN | H |
| II-3-42 | 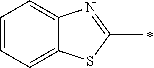 | 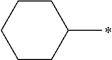 | H |
| II-3-43 | 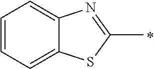 | 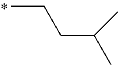 | H |
| II-3-44 | 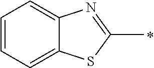 | CH₂CH₃OH | H |
| II-3-45 | 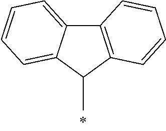 | H | H |
| II-3-46 | 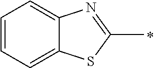 | CH₂CH₃ | H |
| II-3-47 | 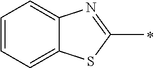 | H | CH₃ |
| II-3-48 | 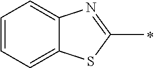 | 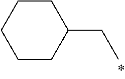 | H |
| II-3-49 | 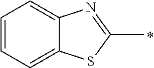 | 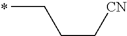 | H |
| II-3-50 | 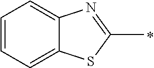 | 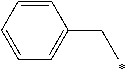 | H |
| II-3-51 | 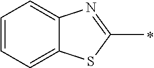 | 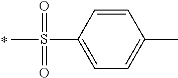 | H |
| II-3-52 | 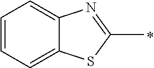 | 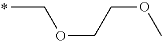 | H |
| II-3-53 | 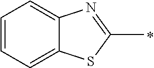 | 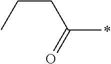 | H |
| II-3-54 | 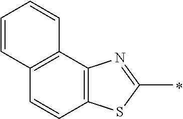 | C₈H₁₀ | H |

| | |
|---|---|
| II-3-55 | 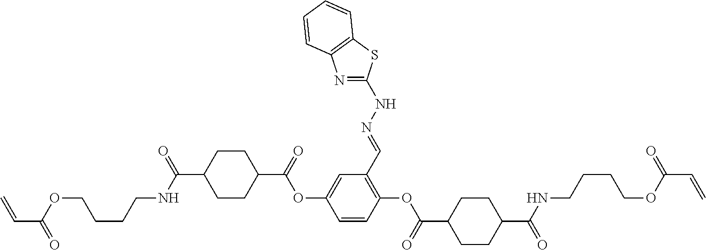 [SMILES: C=CC(=O)OCCCCNC(=O)C1CCC(C(=O)Oc2ccc(OC(=O)C3CCC(C(=O)NCCCCOC(=O)C=C)CC3)c(/C=N/Nc3nc4ccccc4s3)c2)CC1] |
| II-4-1 | 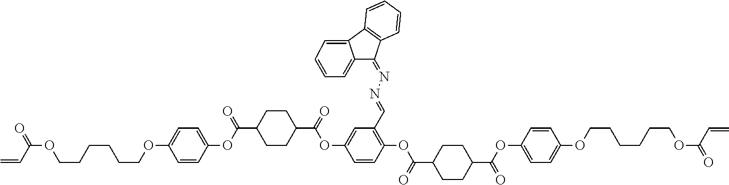 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c(/C=N/N=C4c5ccccc5-c5ccccc54)c3)CC2)cc1] |
| II-4-2 | 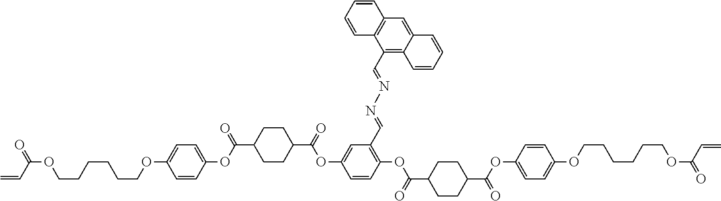 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c(/C=N/N=C/c4c5ccccc5cc5ccccc45)c3)CC2)cc1] |
| II-4-3 | 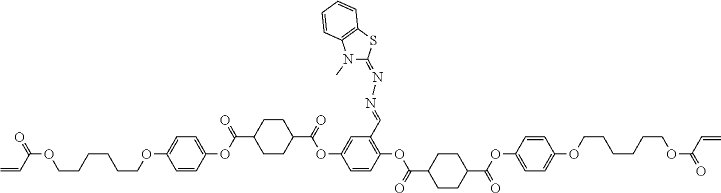 [SMILES: C=CC(=O)OCCCCCCOc1ccc(OC(=O)C2CCC(C(=O)Oc3ccc(OC(=O)C4CCC(C(=O)Oc5ccc(OCCCCCCOC(=O)C=C)cc5)CC4)c(/C=N/N=c4/sc5ccccc5n4C)c3)CC2)cc1] |

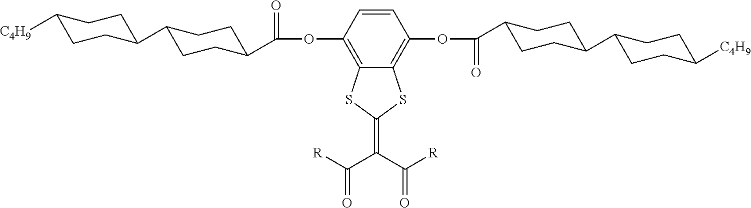

| | |
|---|---|
| (10) | 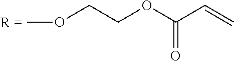 |
| (11) | 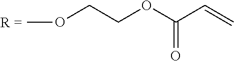 |
| (12) | 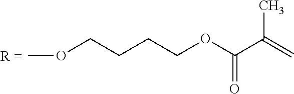 |
| (13) | 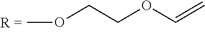 |
| (14) | 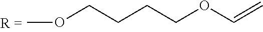 |
| (15) | 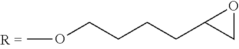 |
| (16) | 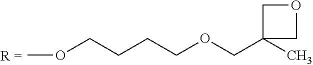 |
| (17) | 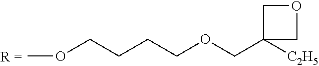 |
| (18) | 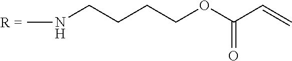 |

Suitable examples of an aspect of the liquid crystal compound represented by Formula (I) include an aspect in which at least one of D¹ or D² is *1-O—CO—, *1-O—CR¹R²—, or *1-O—CO—CR¹R²— from the viewpoints that the compound is easily synthesized and the liquid crystallinity is excellent. *1 represents a bonding position on the Ar side. Among those, in a case where at least one (preferably both) of D¹ or D² is *1-O—CO—, an effect of improving the wet heat resistance is more excellent.

For example, in a case where both of D¹ and D² are *1-O—CO—, the liquid crystal compound represented by Formula (I) is represented by Formula (IV).

L¹-SP¹-A¹-D³-G¹-CO—O—Ar—O—CO-G²-D⁴-A²-SP²-L² Formula (IV)

In the suitable aspect, in a case where D¹ is *1-O—CO—, *1-O—CR¹R²—, or *1-O—CO—CR¹R²—, the wet heat resistance of the optical film is more excellent with a difference between the pKa of the liquid crystal compound represented by Formula (III) including the same structure as a partial structure represented by —O—Ar-D²-G²-D⁴-A²-SP²-L² in Formula (I) and the pKa of the specific acid of 18.0 or more.

HO—Ar-D²-G²-D⁴-A²-SP²-L² Formula (III)

This difference represents a difference between the pKa of a core portion (Ar portion) of the liquid crystal compound represented by Formula (I) and the pKa of the specific acid. In a case where the difference is 18.0 or more, the wet heat resistance of the optical film is more excellent, and the difference is more preferably 21.0 or more. The upper limit of the difference is not particularly limited, but is 30 or less in many cases, and also 25 or less in many cases.

In addition, the structure of Ar in Formula (III) is the same as the structure of the corresponding Ar in Formula (I). Further, the bonding position of Ar of the OH group in Formula (III) is the same as the bonding position of the corresponding Ar of the —O— group in Formula (I). In addition, the bonding position of Ar of D² in Formula (III) is the same as the bonding position of the corresponding Ar of D² in Formula (I). That is, the compound represented by Formula (III) corresponds to an acid corresponding to a partial structure represented by —O—Ar-D²-G²-D⁴-A²-SP²-L² in Formula (I).

From the viewpoint that the wet heat resistance of the optical film is more excellent, the pKa of the compound represented by Formula (III) is preferably 8.0 or more, and more preferably 8.3 or more. The upper limit value of the pKa is not particularly limited, but is 10.0 or less in many cases and preferably 9.5 or less.

In the suitable aspect, in a case where both of D¹ and D² are *1-O—CO—, *1-O—CR¹R²—, or *1-O—CO—CR¹R²—, the wet heat resistance of the optical film is more excellent by setting a difference between the pKa of the liquid crystal compound represented by Formula (II) including the same structure as that of the partial structure represented by —O—Ar—O— in Formula (I) and the pKa of the specific acid to 18.0 or more.

HO—Ar—OH Formula (II)

This difference represents a difference between the pKa of a core portion (Ar portion) of the liquid crystal compound represented by Formula (I) and the pKa of the specific acid. In a case where the difference is 18.0 or more, the wet heat resistance of the optical film is more excellent, and the difference is more preferably 21.0 or more. The upper limit of the difference is not particularly limited, but is 30 or less in many cases, and also 25 or less in many cases.

Furthermore, the structure of Ar in Formula (II) is the same as the structure of the corresponding A in Formula (I). Further, the bonding position of the corresponding Ar of the two OH groups in Formula (II) is the same as the bonding position of Ar of —O— group in Formula (I). That is, the compound represented by Formula (II) corresponds to an acid corresponding to a partial structure represented by —O—Ar—O— in Formula (I).

From the viewpoint that the wet heat resistance of the optical film is more excellent, the pKa of the compound represented by Formula (II) is preferably 8.0 or more, and more preferably 8.3 or more. The upper limit value of the pKa is not particularly limited, but is 10.0 or less in many cases and preferably 9.5 or less.

The pKa of the compound represented by Formula (II) and the compound represented by Formula (III) can be calculated by a method of (i) described in the above-mentioned method for measuring the pKa of the specific acid (a method using the software package 1).

Specific examples of the pKa of the compound represented by Formula (II) are shown below.

| Structure | pKa |
|---|---|
| 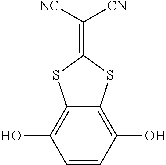 [SMILES: N#CC(C#N)=C1Sc2c(O)ccc(O)c2S1] | 8.3 |
| 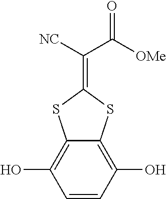 [SMILES: COC(=O)C(C#N)=C1Sc2c(O)ccc(O)c2S1] | 8.42 |
| 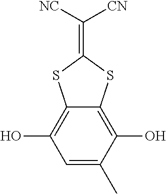 [SMILES: Cc1cc(O)c2c(c1O)SC(=C(C#N)C#N)S2] | 8.71 |
| 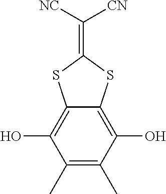 [SMILES: Cc1c(C)c(O)c2c(c1O)SC(=C(C#N)C#N)S2] | 8.75 |
| 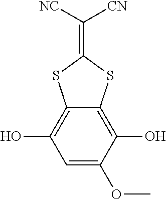 [SMILES: COc1cc(O)c2c(c1O)SC(=C(C#N)C#N)S2] | 8.22 |
| 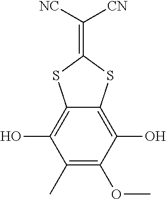 [SMILES: COc1c(C)c(O)c2c(c1O)SC(=C(C#N)C#N)S2] | 8.56 |
| 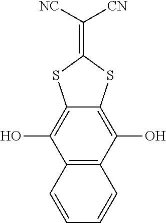 [SMILES: N#CC(C#N)=C1Sc2c(c(O)c3ccccc3c2O)S1] | 7.81 |
| 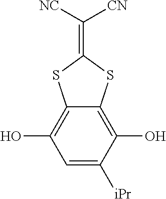 [SMILES: CC(C)c1cc(O)c2c(c1O)SC(=C(C#N)C#N)S2] | 8.66 |
| 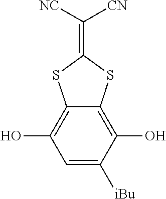 | 8.72 |
| 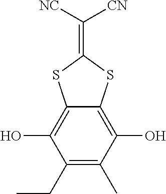 [SMILES: CCc1c(C)c(O)c2c(c1O)SC(=C(C#N)C#N)S2] | 9 |
| 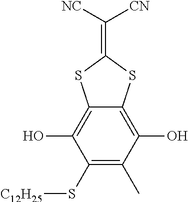 | 7.88 |
| 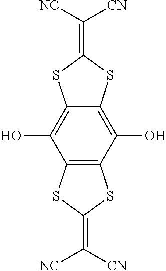 [SMILES: N#CC(C#N)=C1Sc2c(O)c3c(c(O)c2S1)SC(=C(C#N)C#N)S3] | 5.88 |
| 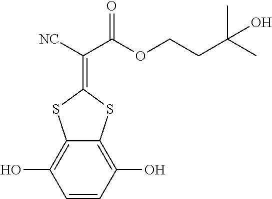 [SMILES: CC(C)(O)CCOC(=O)C(C#N)=C1Sc2c(O)ccc(O)c2S1] | 8.41 |
| 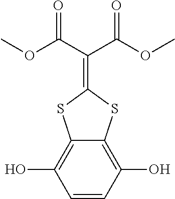 | 8.53 |
| 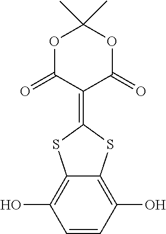 [SMILES: CC1(C)OC(=O)C(=C2Sc3c(O)ccc(O)c3S2)C(=O)O1] | 8.57 |
| 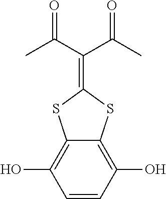 [SMILES: CC(=O)C(C(C)=O)=C1Sc2c(O)ccc(O)c2S1] | 8.49 |
| 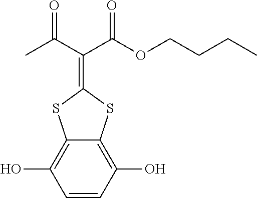 [SMILES: CCCCOC(=O)C(C(C)=O)=C1Sc2c(O)ccc(O)c2S1] | 8.5 |
| 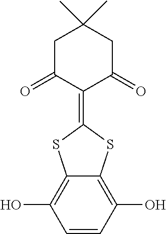 [SMILES: CC1(C)CC(=O)C(=C2Sc3c(O)ccc(O)c3S2)C(=O)C1] | 8.45 |
| 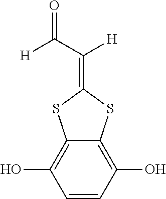 [SMILES: O=CC=C1Sc2c(O)ccc(O)c2S1] | 8.85 |
| 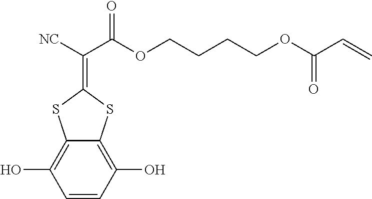 [SMILES: C=CC(=O)OCCCCOC(=O)C(C#N)=C1Sc2c(O)ccc(O)c2S1] | 8.4 |
| 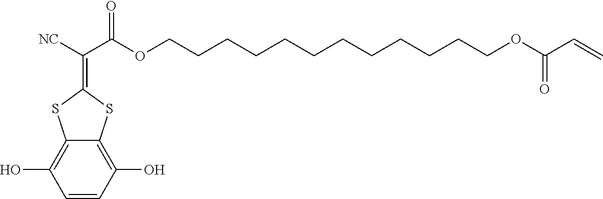 [SMILES: C=CC(=O)OCCCCCCCCCCCCOC(=O)C(C#N)=C1Sc2c(O)ccc(O)c2S1] | 8.41 |
| 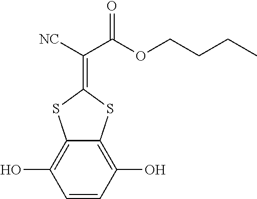 [SMILES: CCCCOC(=O)C(C#N)=C1Sc2c(O)ccc(O)c2S1] | 8.41 |
| 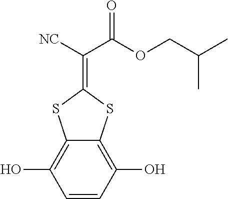 [SMILES: CC(C)COC(=O)C(C#N)=C1Sc2c(O)ccc(O)c2S1] | 8.4 |
| 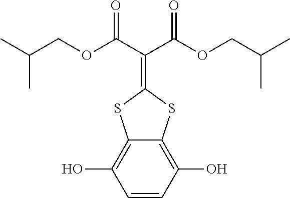 [SMILES: CC(C)COC(=O)C(C(=O)OCC(C)C)=C1Sc2c(O)ccc(O)c2S1] | 8.51 |
| 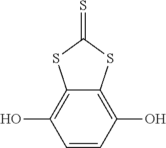 [SMILES: Oc1ccc(O)c2sc(=S)sc12] | 7.84 |
| 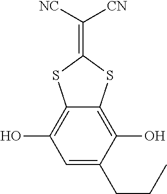 [SMILES: CCCc1cc(O)c2c(c1O)SC(=C(C#N)C#N)S2] | 8.71 |
| 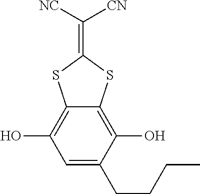 [SMILES: CCCCc1cc(O)c2c(c1O)SC(=C(C#N)C#N)S2] | 8.7 |
| 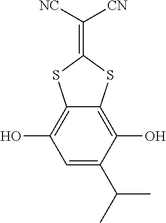 [SMILES: CC(C)c1cc(O)c2c(c1O)SC(=C(C#N)C#N)S2] | 8.66 |
| 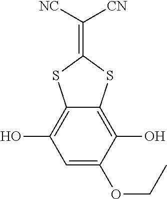 [SMILES: CCOc1cc(O)c2c(c1O)SC(=C(C#N)C#N)S2] | 8.26 |
| 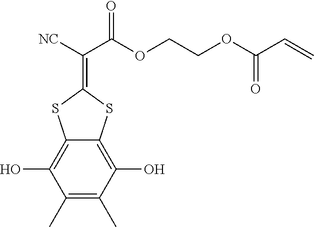 [SMILES: C=CC(=O)OCCOC(=O)C(C#N)=C1Sc2c(O)c(C)c(C)c(O)c2S1] | 8.83 |
| 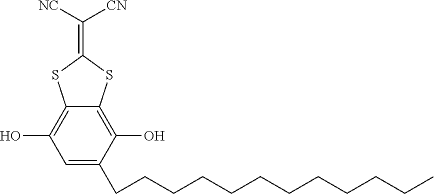 [SMILES: CCCCCCCCCCCCc1cc(O)c2c(c1O)SC(=C(C#N)C#N)S2] | 8.69 |
| 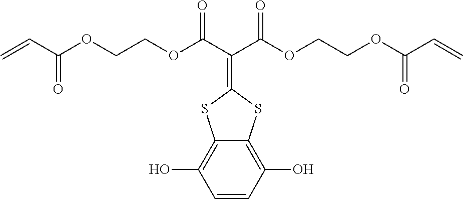 [SMILES: C=CC(=O)OCCOC(=O)C(C(=O)OCCOC(=O)C=C)=C1Sc2c(O)ccc(O)c2S1] | 8.47 |
| 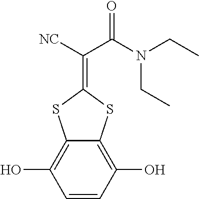 [SMILES: CCN(CC)C(=O)C(C#N)=C1Sc2c(O)ccc(O)c2S1] | 8.48 |
| 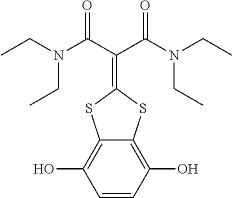 [SMILES: CCN(CC)C(=O)C(C(=O)N(CC)CC)=C1Sc2c(O)ccc(O)c2S1] | 8.67 |
| 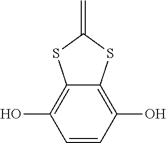 | 8.79 |
| 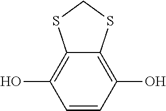 [SMILES: Oc1ccc(O)c2c1SCS2] | 8.99 |
| 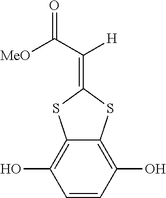 [SMILES: COC(=O)C=C1Sc2c(O)ccc(O)c2S1] | 8.79 |
| 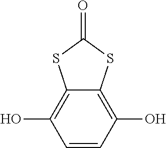 [SMILES: O=c1sc2c(O)ccc(O)c2s1] | 8.19 |
| 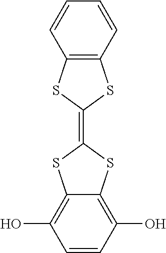 [SMILES: Oc1ccc(O)c2c1SC(=C1Sc3ccccc3S1)S2] | 8.78 |
| 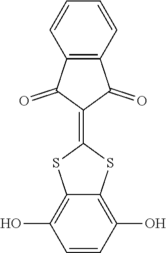 [SMILES: O=C1C(=C2Sc3c(O)ccc(O)c3S2)C(=O)c2ccccc21] | 8.48 |
| 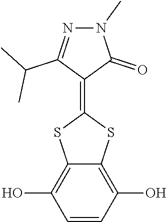 [SMILES: CC(C)C1=NN(C)C(=O)C1=C1Sc2c(O)ccc(O)c2S1] | 8.57 |
| 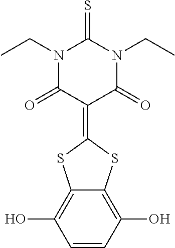 [SMILES: CCN1C(=O)C(=C2Sc3c(O)ccc(O)c3S2)C(=O)N(CC)C1=S] | 8.33 |
| 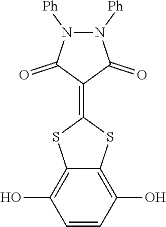 [SMILES: O=C1C(=C2Sc3c(O)ccc(O)c3S2)C(=O)N(c2ccccc2)N1c1ccccc1] | 8.49 |
| 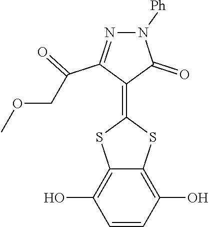 [SMILES: COCC(=O)C1=NN(c2ccccc2)C(=O)C1=C1Sc2c(O)ccc(O)c2S1] | 8.44 |
| 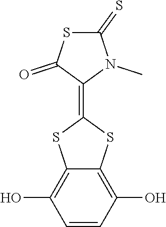 [SMILES: CN1C(=S)SC(=O)C1=C1Sc2c(O)ccc(O)c2S1] | 8.51 |
| 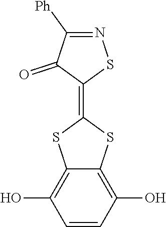 [SMILES: O=C1C(c2ccccc2)=NSC1=C1Sc2c(O)ccc(O)c2S1] | 8.53 |
| 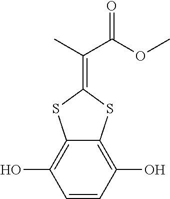 [SMILES: COC(=O)C(C)=C1Sc2c(O)ccc(O)c2S1] | 8.83 |
| 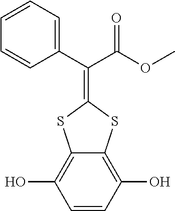 [SMILES: COC(=O)C(=C1Sc2c(O)ccc(O)c2S1)c1ccccc1] | 8.76 |
| 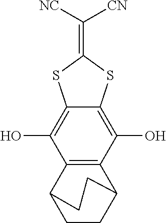 [SMILES: N#CC(C#N)=C1Sc2c(O)c3c(c(O)c2S1)C1CCC3CC1] | 8.24 |
| 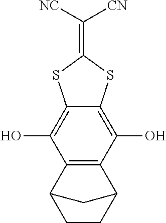 [SMILES: N#CC(C#N)=C1Sc2c(O)c3c(c(O)c2S1)C1CCC3C1] | 8.64 |
| 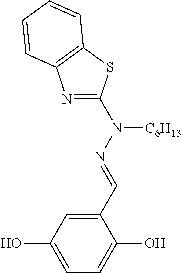 | 9.56 |
| 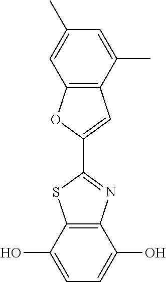 [SMILES: Cc1cc(C)c2cc(-c3nc4c(O)ccc(O)c4s3)oc2c1] | 8.82 |

Components other than the above-mentioned liquid crystal compound represented by Formula (I) may also be included in the polymerizable liquid crystal composition. Hereinafter, the optional components will be described in detail.

The polymerizable liquid crystal composition preferably includes a polymerization initiator.

As the polymerization initiator, a photopolymerization initiator capable of initiating a polymerization reaction upon irradiation with ultraviolet rays is preferable.

Examples of the photopolymerization initiator include α-carbonyl compounds (described in each of the specifications of U.S. Pat. Nos. 2,367,661A and 2,367,670A), acyloin ethers (described in the specification of U.S. Pat. No. 2,448,828A), α-hydrocarbon-substituted aromatic acyloin compounds (described in the specification of U.S. Pat. No. 2,722,512A), multinuclear quinone compounds (as described in each of the specifications of U.S. Pat. Nos. 3,046,127A and 2,951,758A), combinations of triarylimidazole dimer and p-aminophenyl ketone (as described in the specification of U.S. Pat. No. 3,549,367A), oxadiazole compounds (described in the specification of U.S. Pat. No. 4,212,970A), and acyl phosphine oxide compounds (described in each of the specifications of JP1988-040799B (JP-S63-040799B), JP1993-029234B (JP-H05-029234B), JP1998-095788A (JP-H10-095788A), and JP1998-029997A (JP-H10-029997A)).

In a case where the polymerizable liquid crystal composition includes a polymerization initiator, the content of the polymerization initiator is preferably 0.5 to 10 parts by mass, and more preferably 1 to 10 parts by mass, with respect to 100 parts by mass of the liquid crystal compound represented by Formula (I) included in the polymerizable liquid crystal composition.

The polymerization initiator may be used alone or in combination of two or more kinds thereof. In a case where two or more kinds of the polymerization initiators are used, the total content thereof is preferably within the range.

It is preferable that the polymerizable liquid crystal composition includes a solvent from the viewpoint of workability for forming a retardation layer. The type of the solvent is not particularly limited, and examples of the solvent include the above-mentioned solvents (particularly the organic solvents) which may be included in the composition for forming an alignment layer.

The polymerizable liquid crystal composition may include other components than the above components, and examples of such other components include an antioxidant (for example, a phenol-based antioxidant), a liquid crystal compound other than the above liquid crystal compounds, an air interface alignment agent (leveling agent), a surfactants, a tilt angle control agent, an alignment aid, a plasticizer, and a crosslinking agent.

<Method for Producing Optical Film>

A method for producing the optical film is not particularly limited as long as it can produce an alignment layer or retardation layer having the above-described configuration. Hereinafter, a method for producing each of the layers will be described in detail.

(Method of Producing Alignment Layer)

As a method for producing the alignment layer, a known method can be appropriately adopted and used.

Examples of the method include a method in which a composition for forming an alignment layer is applied to form a coating film and the coating film is subjected to a rubbing treatment to obtain an alignment layer.

The above-mentioned known polymer for an alignment layer is preferably included in the composition for forming an alignment layer.

A method for applying the composition for forming an alignment layer is not particularly limited and can be appropriately selected depending on the purpose, and examples thereof include spin coating, die coating, gravure coating, flexographic printing, and ink jet printing.

Examples of the method for a rubbing treatment include known methods.

Moreover, in a case where an alignment layer including a specific acid or a salt thereof is formed, examples of a method for forming the alignment layer include a method in which an alignment layer is formed by the above-mentioned procedure using a composition for forming an alignment layer, including a specific acid or a salt thereof.

The total content of the specific acid and a salt thereof in the composition for forming an alignment layer is not particularly limited, and the total content of the specific acid and a salt thereof in the above-mentioned alignment layer is appropriately adjusted.

In a case where the alignment layer is a so-called photoalignment layer, examples of the method for forming an alignment layer include a method in which a composition for forming a photoalignment layer is applied to form a coating film, and the coating film is irradiated with polarized light or irradiated with unpolarized light in an oblique direction with respect to a surface of the coating film (hereinafter also collectively referred to a “photoalignment treatment”) to obtain a photoalignment layer.

A known photoalignable material is included in the composition for forming a photoalignment layer, and as the photoalignable material, a mixture of the polymer A having a constitutional unit a1 containing a cinnamate group and the low-molecular-weight compound B having a cinnamate group having a molecular weight lower than that of the polymer A, each as described, is preferable.

Examples of a method for applying the composition for forming a photoalignment layer include the above-mentioned application method.

Polarized light to be irradiated onto the coating film of the composition for forming a photoalignment layer is not particularly limited, and examples thereof include linearly polarized light, circularly polarized light, and elliptically polarized light, with the linearly polarized light being preferable.

In addition, the “oblique direction” for irradiating unpolarized light is not particularly limited as long as it is a direction included at a polar angle θ (0°<θ<90°) with respect to the normal direction of a surface of the coating film, and can be appropriately selected depending on the purpose, but θ is preferably 20° to 80°.

The wavelength of the polarized light or the unpolarized light is not particularly limited as long as it can impart alignment controllability for the liquid crystal compound onto the coating film, and examples of the light include ultraviolet rays, near-ultraviolet rays, and visible light. Among those, near-ultraviolet rays at 250 to 450 nm are preferable.

Incidentally, examples of a light source for irradiating polarized or unpolarized light include a xenon lamp, a high-pressure mercury lamp, an ultra-high-pressure mercury lamp, and a metal halide lamp. With regard to the ultraviolet rays or the visible light obtained from such the light source, it is possible to limit a wavelength range to be irradiated by using an interference filter or a color filter. Further, with regard to light from these light sources, it is possible to obtain linearly polarized light by using a polarizing filter or a polarizing prism.

An integrated light quantity of the polarized light or the unpolarized light is not particularly limited as long as it can impart alignment controllability for the liquid crystal compound onto the coating film, but is preferably 1 to 300 mJ/cm², and more preferably 5 to 100 mJ/cm².

An illuminance of the polarized light or the unpolarized light is not particularly limited as long as it can impart alignment controllability for the liquid crystal compound onto the coating film of the composition for forming a photoalignment layer, but is preferably 0.1 to 300 mW/cm², and more preferably 1 to 100 mW/cm².

Moreover, in the case of forming a photoalignment layer including a specific acid or a salt thereof, examples of a method for forming the photoalignment layer include a method in which an alignment layer is formed by the above-mentioned procedure using a composition for forming a photoalignment layer including a specific acid or a salt thereof.

Furthermore, in a case where a thermal acid generator that generates a specific acid is included in the composition for forming an alignment layer, it is possible to perform a heating treatment to generate a specific acid, and thus, form an alignment layer including the specific acid in any one step of forming the alignment layer.

For example, in a case where the composition for forming an alignment layer includes a compound having a crosslinkable group that crosslinks by a specific acid (for example, a polymer A having a constitutional unit a2 containing a crosslinkable group), it is preferable that a composition for forming an alignment layer is applied and then the coating film is subjected to a heating treatment to make a crosslinking reaction of the crosslinkable group proceed while generating the specific acid. Incidentally, by performing a rubbing treatment or a photoalignment treatment afterwards, it is possible to form an alignment layer.

The thermal acid generator is not particularly limited in terms of its structure as long as it is a compound that decomposes by heat to generate a specific acid, but is usually constituted of an anion formed by removing a hydrogen ion from the specific acid and a cation.

The type of the specific acid is as described above.

Specific examples of the anion include the following ones.

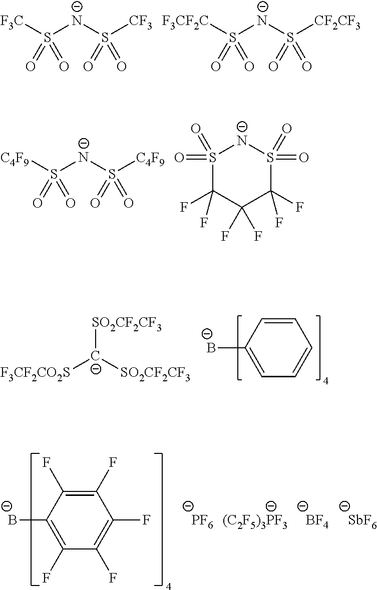

As the cation, a known cation that substantially decomposes by heat can be used. The cation preferably has a skeleton that initiates thermal decomposition at 30° C. to 200° C., and more preferably has a skeleton that initiates thermal decomposition at 40° C. to 150° C. Among those, from the viewpoint of handling properties, a sulfonium cation represented by Formula (F) or an iodonium cation represented by Formula (G) is preferable.

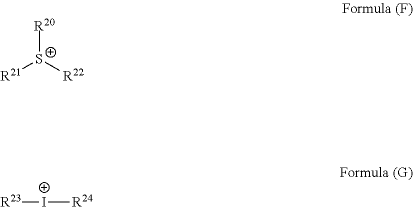

R²⁰ to R²⁴ each independently represent a hydrocarbon group which may have a substituent. As the hydrocarbon group, an alkyl group (for example, a methyl group and an ethyl group) or an aryl group (for example, a phenyl group) is preferable.

The type of the substituent is not particularly limited, and examples thereof include an alkyl group, an aryl group, a hydroxy group, an amino group, a carboxy group, a sulfonamido group, an N-sulfonylamido group, an acyl group, an acyloxy group, an alkoxy group, an alkyl group, a halogen atom, an alkoxycarbonyl group, an alkoxycarbonyloxy group, a carbonic acid ester group, and a cyano group.

Specific examples of the cation include the following ones.

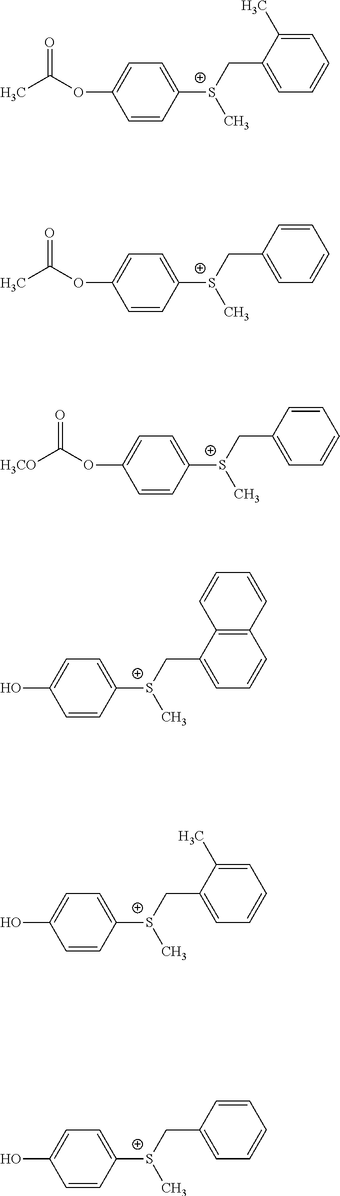 [SMILES: CC(=O)Oc1ccc([S+](C)Cc2ccccc2C)cc1 ; CC(=O)Oc1ccc([S+](C)Cc2ccccc2)cc1 ; COC(=O)Oc1ccc([S+](C)Cc2ccccc2)cc1 ; C[S+](Cc1cccc2ccccc12)c1ccc(O)cc1 ; Cc1ccccc1C[S+](C)c1ccc(O)cc1 ; C[S+](Cc1ccccc1)c1ccc(O)cc1]

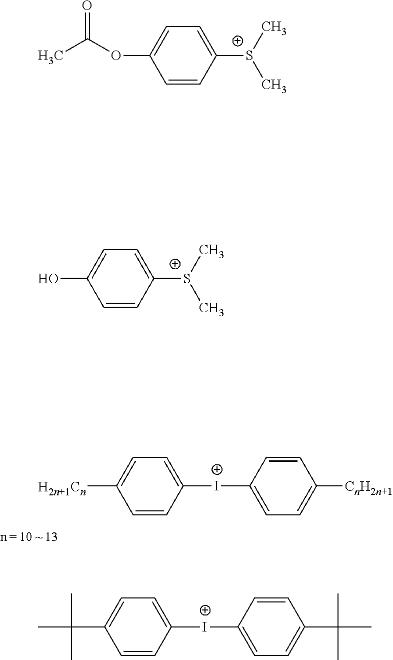

Specific examples of the thermal acid generator include the following ones.

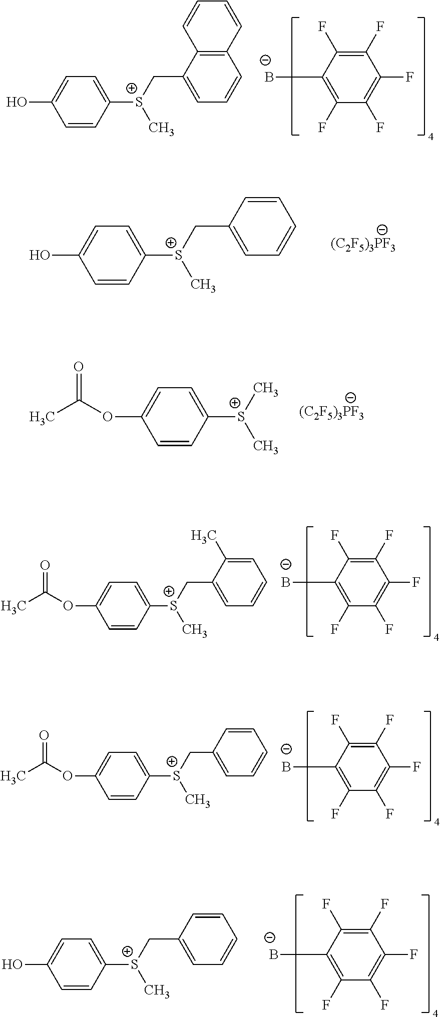

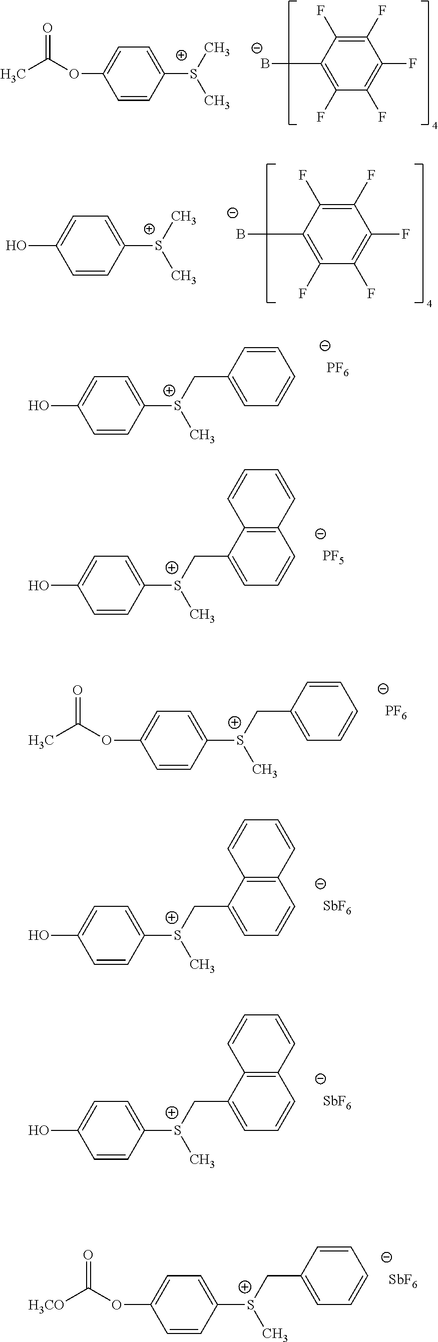

Furthermore, in a case where a photoacid generator that generates a specific acid is included in the composition for forming an alignment layer, it is possible to form an alignment layer including the specific acid by performing a light irradiation treatment in any one of steps during the formation of an alignment layer to generate a specific acid.

For example, in a case where the alignment layer is a photoalignment layer, the specific acid may be generated in combination by performing a photoalignment treatment.

In a case where the composition for forming an alignment layer includes an acid generator such as the thermal acid generators and photoacid generators as mentioned above, the composition for forming an alignment layer may further include a cationic polymerization inhibitor and/or a radical polymerization inhibitor.

In a case where the composition for forming an alignment layer is stored over a long period of time, the acid generator is cleaved to generate a specific acid in some cases. In a case where the polymer for an alignment layer included in the composition for forming an alignment layer has a cationically polymerizable group, a reaction proceeds in some cases by a specific acid generated during the storage of the composition for forming an alignment layer as described above. Thus, in order to improve the storage stability of the composition for forming an alignment layer, it is possible to suppress the progress of the reaction as described above by adding a cationic polymerization inhibitor to the composition for forming an alignment layer.

In addition, in a case where the acid generator is cleaved, radicals are generated in some cases. In a case where the polymer for an alignment layer included in the composition for forming an alignment layer has a radically polymerizable group, a reaction proceeds in some cases by a radical generated during the storage of the composition for forming an alignment layer as described above. Thus, in order to improve the storage stability of the composition for forming an alignment layer, it is possible to suppress the progress of the reaction as described above by adding a radical polymerization inhibitor to the composition for forming an alignment layer.

The content of the cationic polymerization inhibitor in the composition for forming an alignment layer is not particularly limited, but is preferably 0.1 to 10.0 parts by mass, and more preferably 0.5 to 5.0 parts by mass, with respect to 100 parts by mass of the acid generator.

In addition, the content of the radical polymerization inhibitor in the composition for forming an alignment layer is not particularly limited, but is preferably 0.1 to 10.0 parts by mass, and more preferably 0.5 to 5.0 parts by mass, with respect to 100 parts by mass of the acid generator.

Examples of the cationic polymerization inhibitor include a salt of a weak acid, and the cationic polymerization inhibitor is preferably an acid generator constituted with an anion formed by removing a hydrogen ion from the weak acid and a cation.

As the weak acid, an acid such that a reaction of a cationically polymerizable group does not proceed is preferable. For example, as the weak acid, an acid having an acid strength that is lower than that of trifluoromethanesulfonic acid is preferable. The pKa of the weak acid is preferably −8.0 or more, and more preferably −5.0 or more. The upper limit is not particularly limited, and is preferably 6.0 or less.

Specific examples of the anion (anion formed by removing a hydrogen ion from a weak acid) are shown below.

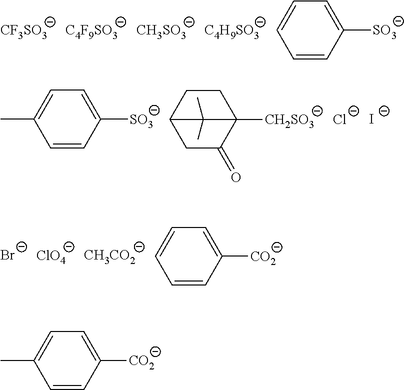

The type of the cation is not particularly limited, but examples thereof include cations included in the thermal acid generator as mentioned above. Specific examples of the cation are shown below.

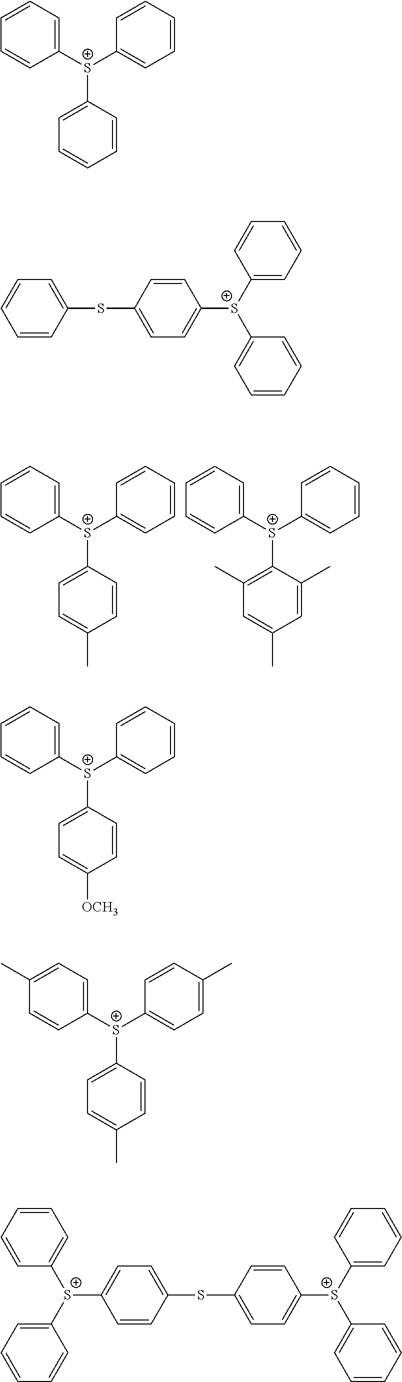

Specific examples of the cationic polymerization inhibitor are shown below.

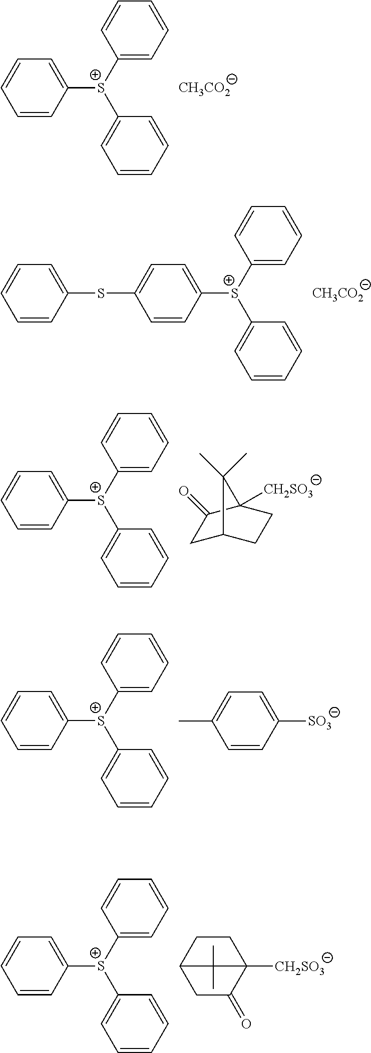

The radical polymerization inhibitor is not particularly limited in terms of its type as long as it is a compound capable of supplementing a radical. Among those, a compound having an N-oxyl structure is preferable, and a compound represented by Formula (H) is more preferable.

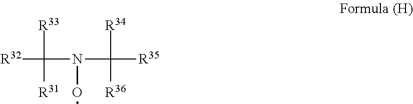

In Formula (H), R³¹, R³², R³⁵, and R³⁶ each independently represent a hydrogen atom, an alkyl group, or an aryl group.

R³³ and R³⁴ each independently represent an alkyl group, an aryl group, or an alkoxy group. In a case where R³³ and R³⁴ are each an alkyl group or an alkoxy group, R³³ and R³⁴ may be linked to each other to constitute a ring.

As the alkyl group in each of R³¹ to R³⁶, a linear, branched, or cyclic alkyl group having 1 to 18 carbon atoms is preferable, a linear, branched, or cyclic alkyl group having 1 to 6 carbon atoms is more preferable, a linear or branched alkyl group having 1 to 6 carbon atoms is still more preferable, and a linear alkyl group having 1 to 6 carbon atoms is particularly preferable.

As the aryl group in each of R³¹ to R³⁶, an aryl group having 6 to 10 carbon atoms is preferable, and examples thereof include a phenyl group and a naphthyl group.

As the alkoxy group in each of R³³ and R³⁴, an alkoxy group having 1 to 18 carbon atoms is preferable, and an alkoxy group having 1 to 6 carbon atoms is more preferable.

In a case where R³³ and R³⁴ are each an alkyl group or an alkoxy group, R³³ and R³⁴ may be linked to each other to constitute a ring. In this case, Formula (H) has at least a nitrogen atom-containing saturated heterocyclic skeleton (saturated nitrogen-containing heterocyclic skeleton).

Such the saturated nitrogen-containing heterocyclic skeleton is preferably a 5- to 8-membered ring, more preferably a 5- or 6-membered ring, and still more preferably a 6-membered ring.

Examples of the saturated nitrogen-containing heterocyclic skeleton include a pyrrolidine skeleton, a piperidine skeleton, a morpholine skeleton, and an oxazolidine skeleton.

The aryl group and the alkyl group in each of R³¹ to R³⁶ and the alkoxy group in each of R³³ and R³⁴ may have a substituent.

As the compound represented by Formula (H), a compound represented by Formula (I) is preferable.

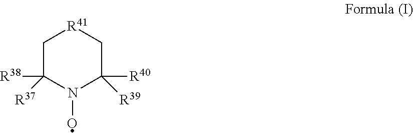

In Formula (I), R³⁷ to R⁴⁰ each independently represent a hydrogen atom, an alkyl group, or an aryl group.

In Formula (I), R⁴¹ represents an oxygen atom or a —C(R⁴²R⁴³)— group. R⁴² and R⁴³ each independently represent a hydrogen atom, an alkyl group, an aryl group, an alkoxy group, an aryloxy group, a carboxy group, or a carboxyalkyl group.

R³⁷ to R⁴⁰ each independently represent a hydrogen atom, an alkyl group, or an aryl group, and have the same definitions and preferred aspects as R³¹, R³², R³⁵, and R³⁶, respectively, in Formula (H) as mentioned above.

R⁴¹ represents an oxygen atom or a —C(R⁴²R⁴³)— group, but is preferably a —C(R⁴²R⁴³)— group.

Specific examples of the radical polymerization inhibitor are shown below, but are not limited thereto.

| | |
|---|---|
| | Formula (I) |
| 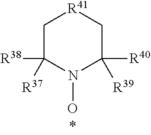 | |

| No | R³⁷ | R³⁸ | R³⁹ | R⁴⁰ | R⁴¹ |
|---|---|---|---|---|---|
| 1 | CH₃ | CH₃ | CH₃ | CH₃ | CH₂ |
| 2 | CH₃ | CH₃ | CH₃ | CH₃ | O |
| 3 | CH₃ | CH₃ | CH₃ | CH₃ | CH(COOH) |
| 4 | CH₃ | CH₃ | CH₃ | CH₃ | CH(COOC₂H₅) |

(Method for Producing Retardation Layer)

A method for forming a retardation layer is not particularly limited.

Examples of the method include a method in which a polymerizable liquid crystal composition including the liquid crystal compound represented by Formula (I) is applied onto the alignment layer formed above to form a coating film to align the liquid crystal compound and the coating film is subjected to a curing treatment (a light irradiation treatment or a heating treatment). By this method, the aligned liquid crystal compound can be fixed.

The composition of the polymerizable liquid crystal composition is as described above.

Examples of a method of applying the polymerizable liquid crystal composition include the same method as a method of applying the composition for forming an alignment layer.

A method of aligning the liquid crystal compound in the coating film is not particularly limited, and a known method can be adopted and used. Examples of the method include a heating treatment.

A method for the curing treatment is not particularly limited, and examples thereof include a light irradiation treatment and a heating treatment. Among those, from the viewpoint of productivity, the light irradiation treatment is preferable, and the ultraviolet ray irradiation treatment is more preferable.

An irradiation dose during the light irradiation treatment is preferably 10 mJ/cm² to 50 J/cm², and more preferably 20 mJ/cm² to 5 J/cm², still more preferably 30 mJ/cm² to 3 J/cm², and particularly preferably 50 to 1,000 mJ/cm². Incidentally, the light irradiation treatment may be carried out under a heating condition in order to accelerate the polymerization reaction.

In the case of forming a retardation layer including a specific acid or a salt thereof, examples of a method for forming the retardation layer include a method for forming a retardation layer by the above-mentioned procedure using a polymerizable liquid crystal composition including a specific acid or a salt thereof.

Moreover, in a case where a thermal acid generator that generates a specific acid is included in the polymerizable liquid crystal composition, it is possible to form a retardation layer including a specific acid by carrying out a heating treatment in any one of the steps during the formation of a retardation layer to generate the specific acid. For example, the specific acid may be generated in combination during the heating treatment in the case of aligning the liquid crystal compound.

In addition, in a case where a photoacid generator that generates a specific acid is included in the polymerizable liquid crystal composition, it is possible to form a retardation layer including a specific acid by carrying out a light irradiation treatment in any one of the steps during the formation of a retardation layer to generate the specific acid. For example, the specific acid may be generated in combination while carrying out the light irradiation treatment as the curing treatment.

Incidentally, as will be described in detail in paragraphs below, the optical film may include other layers in addition to the alignment layer and the retardation layer (for example, a support, a hard coat layer, and a pressure sensitive adhesive layer).

Preferred examples of a method for producing an optical film having an alignment layer including a specific acid include a method including a step in which a composition for forming an alignment layer including a thermal acid generator that generates a specific acid and a compound having a photoalignable group is applied to form a coating film, the coating film is subjected to a heating treatment, the coating film that has been subjected to the heating treatment is subjected to a photoalignment treatment to obtain an alignment layer, and a step in which a polymerizable liquid crystal composition is applied onto an alignment layer to form a coating film, the coating film is subjected to a heating treatment to align the liquid crystal compound, and the coating film is subjected to a curing treatment to obtain a retardation layer. According to the procedure, a specific acid is generated from a thermal acid generator during the heating treatment during the formation of the alignment layer. Incidentally, in a case where the compound having a photoalignable group has a cationically polymerizable group, it is possible to obtain an alignment layer having an excellent strength by allowing cationic polymerization to proceed by the generated specific acid. The procedure for the photoalignment treatment is as described above.

In addition, preferred examples of a method for producing an optical film having the retardation layer including a specific acid include a method in which a polymerizable liquid crystal composition including the liquid crystal compound represented by Formula (I) and the thermal acid generator that generates a specific acid onto an alignment layer to form a coating film, the coating film is subjected to a heating treatment to align the liquid crystal compound, and the coating film is subjected to a curing treatment to obtain a retardation layer. According to the procedure, the specific acid is generated from a thermal acid generator while heating the coating film.

### Second Embodiment

FIG. 2 is a schematic cross-sectional view of a second embodiment of the optical film. In FIG. 2, an optical film 10B includes a support 16, an alignment layer 12 disposed on the support 16, and a retardation layer 14 disposed adjacent to the alignment layer 12.

The optical film 10B shown in FIG. 2 has the same layer as the optical film 10A shown in FIG. 1 except for the support 16, and therefore, the same references are assigned to the same components, the descriptions of which are omitted. In the following, the support 16 will be mainly described in detail.

(Support) The support is a member for supporting the alignment layer and the retardation layer.

The support is preferably a transparent, and specifically, it has preferably a light transmittance of 80% or more.

Examples of the support include a glass substrate and a polymer film. Examples of the material of the polymer film include cellulose-based polymers; acrylic polymers; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer; vinyl chloride-based polymers; amide-based polymer such as nylon and an aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; or a polymer obtained by mixing these polymers.

In addition, a polarizer which will be described later may also be in an aspect which it also serves as such a support.

The thickness of the support is not particularly limited, but is preferably 5 to 60 μm, and more preferably 5 to 30 μm.

Moreover, the support may be used as a subject onto which the above-mentioned composition for forming an alignment layer will be applied, or may also be used directly as a part of the optical film.

In the second embodiment, the aspect in which the optical film includes a support has been described, and in addition, a hard coat layer, an adhesive layer, and the like may be included in the optical film.

<Polarizing Plate>

The polarizing plate of an embodiment of the present invention has the optical film of the embodiment of the present invention described above and a polarizer.

The polarizer is not particularly limited as long as it is a member having a function of converting light into specific linearly polarized light, and examples thereof include a known absorptive polarizer and a reflective polarizer.

Examples of the absorptive polarizer include an iodine-based polarizers, a dye-based polarizer using a dichroic dye, and a polyene-based polarizer. The iodine-based polarizer and the dye-based polarizer can be classified into a coating-type polarizer and a stretching type polarizer, both of which is applicable, and a polarizer manufactured by adsorbing iodine or a dichroic dye onto a polyvinyl alcohol, followed by stretching, is preferable.

Furthermore, examples of a method for obtaining a polarizer by performing stretching and dyeing in a state of a laminated film having a polyvinyl alcohol layer formed on a substrate include the methods described in JP5048120B, JP5143918B, JP5048120B, JP4691205B, JP4751481B, and JP4751486B, and known techniques for these polarizers can also be preferably used.

As the reflective polarizer, a polarizer formed by laminating thin films having different birefringences, a wire grid type polarizer, a polarizer obtained by combining a cholesteric liquid crystal having a selective reflection range and a ¼ wavelength plate, or the like is used.

The thickness of the polarizer is not particularly limited, but is preferably 3 to 60 μm, more preferably 5 to 30 μm, and still more preferably 5 to 15 μm.

[Image Display Device]

The image display device of an embodiment of the present invention is an image display device having the optical film of the embodiment of the present invention or the polarizing plate of the embodiment of the present invention. More specifically, the image display device of the embodiment of the present invention has a display element, and an optical film or polarizing plate.

The display element used in the image display device of the embodiment of the present invention is not particularly limited, and examples thereof include a liquid crystal cell, an organic electroluminescent (hereinafter abbreviated as “EL”) display panel, and a plasma display panel.

As the image display device, a liquid crystal display device using a liquid crystal cell as a display element or an organic EL display device using an organic EL display panel as a display element is preferable, and the liquid crystal display device is more preferable.

### EXAMPLES

Hereinafter, the present invention will be described in more detail with reference to Examples. The materials, the amounts of materials used, the proportions, the treatment details, the treatment procedure, and the like shown in Examples below may be modified, as appropriate, as long as the modifications do not depart from the spirit of the present invention. Therefore, the scope of the present invention should not be construed as being limited to Examples shown below.

<Synthesis of Liquid Crystal Compound>

(Synthesis of Compound (A-1))

According to the synthetic method of Example 4 of JP2016-081035A, a compound (A-1) was synthesized.

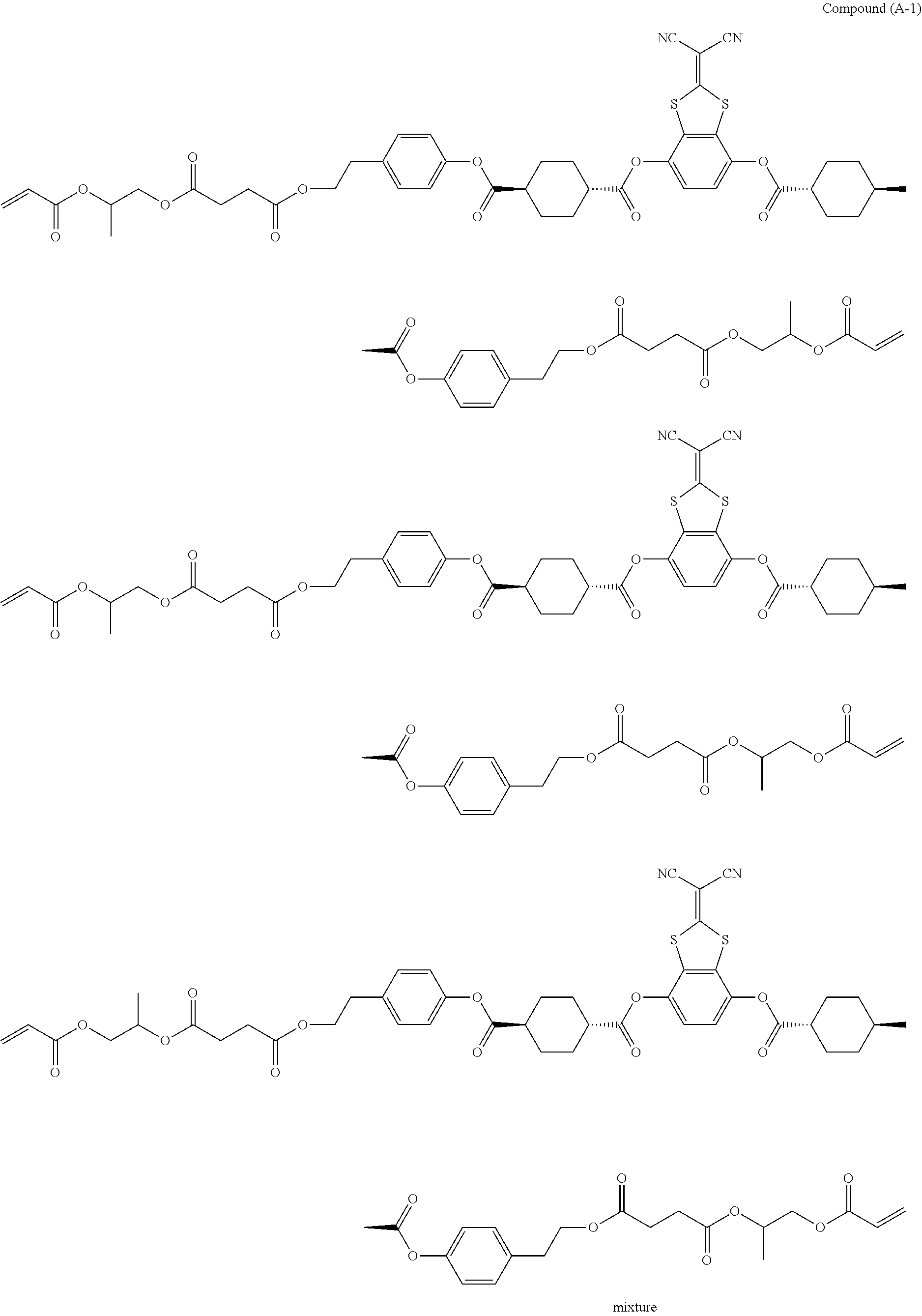

(Synthesis of Compound (A-2))

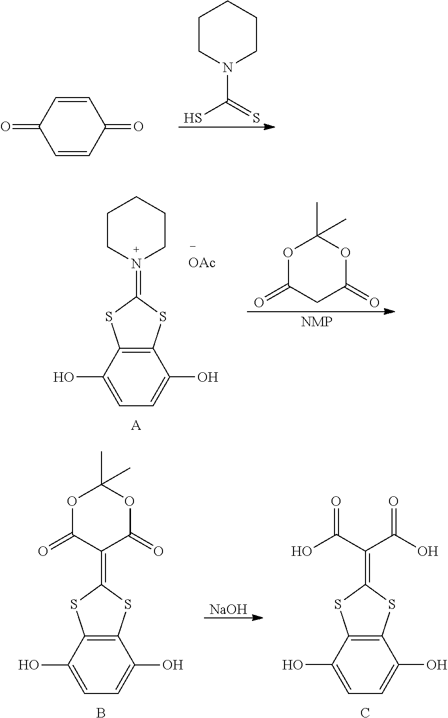

According to the method described in Journal of Organic Chemistry (2004); 69(6); p. 2164-2177, a compound (A) was synthesized.

30.0 g (0.0916 mol) of the compound (A), 19.8 g (0.137 mol) of Meldrum's acid, and 200 mL of N-methyl-2-pyrrolidone (NMP) were mixed and the obtained mixture was stirred at 55° C. for 2 hours. After completion of the stirring, the mixture was cooled to room temperature, 200 mL of water was added to the mixture, and the crystal precipitated in the mixture was recovered through filtration. The obtained crystal was washed with a mixed solution of water-NMP (1 to 1) to obtain 28.4 g (0.0870 mol) of a compound (B) (yield: 95%).

51.5 g (0.158 mol) of the compound (B) and 315 mL of tetrahydrofuran (THF) were mixed, the obtained mixture was cooled under ice-cooling, and 395 mL (0.789 mol) of a 2 M aqueous sodium hydroxide solution was added dropwise to the cooled mixture. The obtained mixture was warmed to room temperature and the mixture was stirred for 2 hours. The obtained mixture was cooled under ice-cooling, and 263 mL (0.789 mol) of 3 N aqueous hydrochloric acid was added dropwise to the cooled mixture. 300 mL of water and 180 mL of isopropyl alcohol (IPA) were added to the obtained mixture, and the solid precipitated in the mixture was recovered through filtration. The obtained solid was stirred in acetonitrile and the solid in acetonitrile was recovered through filtration to obtain 25 g (0.0868 mol) of a compound (C) (yield: 55%).

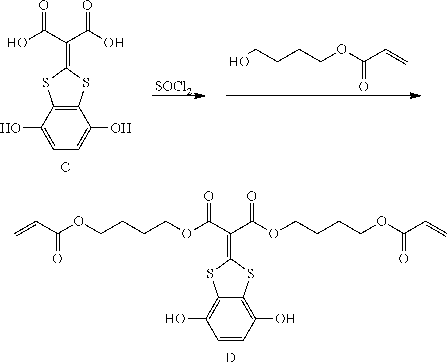

50 g (0.175 mol) of the compound (C), dibutylhydroxytoluene (BHT) (1.9 g, 8.74 mmol), 300 mL of THF, and 150 mL of N,N-dimethylacetamide (DMAc) were mixed, the obtained mixture was cooled under ice-cooling, and 87.3 g (0.734 mol) of thionyl chloride was added dropwise to the cooled mixture. The mixture was stirred for 2 hours under ice-cooling, and then 126 g (0.874 mol) of 4-hydroxybutylacrylic acid ester was added dropwise to the mixture. The obtained mixture was warmed to room temperature and stirred for 2 hours, and then the organic phase was extracted and recovered by the addition of 400 mL of 5% saline, 100 mL of ethyl acetate, and 200 mL of THF to the mixture. The recovered organic phase was washed twice with 200 mL of 10% saline, then the organic phase was dried over magnesium sulfate, and the solvent was distilled off from the organic phase under reduced pressure. The obtained crude product was stirred with acetonitrile and the solid in acetonitrile was recovered through filtration to obtain 57 g (0.107 mol) of a compound (D) (yield: 61%).

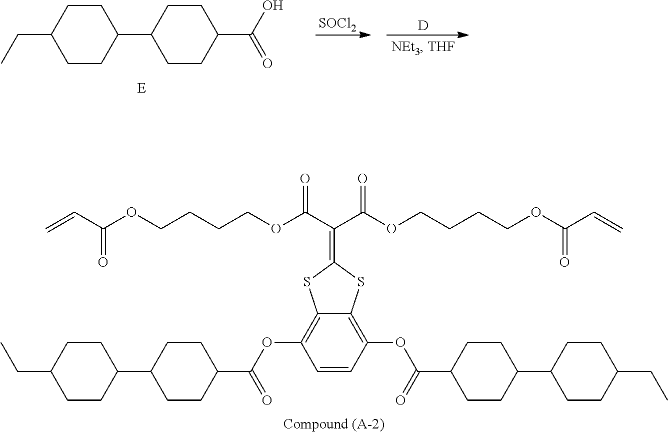

12.7 g (0.107 mmol) of thionyl chloride was added to a solution of 22.1 g (0.0928 mol) of a compound (E) in 40 mL of toluene, and a catalytic amount of N,N-dimethylformamide was added thereto. The obtained mixture was warmed to 65° C. and stirred for 2 hours, and then the solvent was distilled off from the mixture. The obtained residue, 25 g (0.0464 mol) of the compound (D), BHT (0.51 g, 2.32 mmol), and THF (125 mL) were mixed, then the obtained mixture was cooled under ice-cooling, and 10.3 g (0.102 mol) of triethylamine was added dropwise to the cooled mixture. The obtained mixture was warmed to room temperature and stirred for 2 hours, and then the organic phase was extracted and recovered by the addition of 100 ml of 1 M aqueous hydrochloric acid and 40 mL of ethyl acetate to the mixture. The recovered organic phase was washed with 10% saline, then 400 ml of methanol was added to the organic phase, and the precipitated solid was recovered through filtration to obtain 38 g (0.0389 mol) of a compound (A-2) (yield: 84%).

(Synthesis of Compound (A-3))

According to the method described in paragraphs 0462 to 0477 of JP2011-207765A, a compound (A-3) was synthesized.

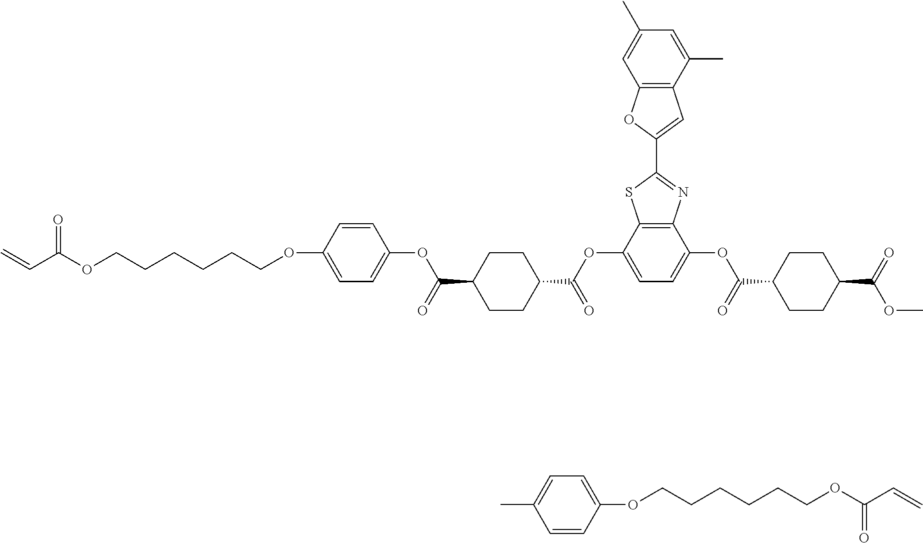

(Synthesis of Compound (A-4))

According to the method described in paragraphs 0205 to 0217 of WO2014-010325A, a compound (A-4) having the following structure was synthesized.

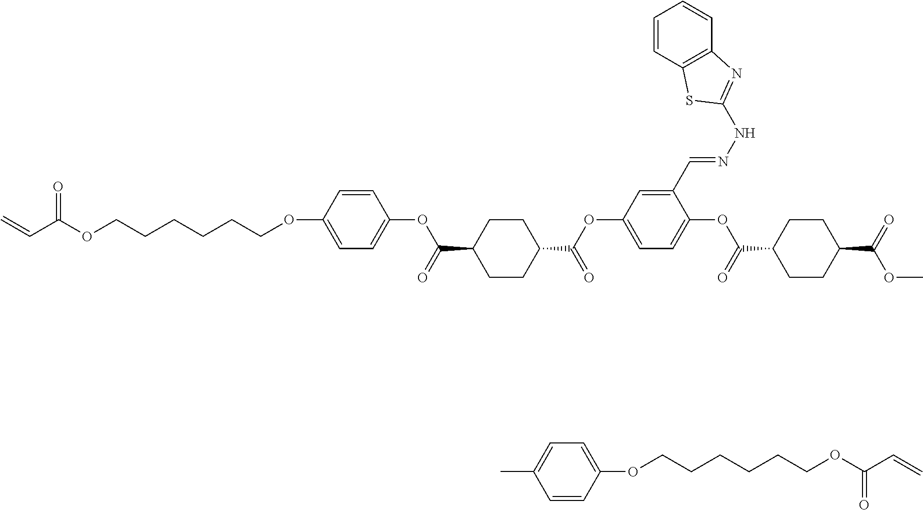

Synthesis of Polymer or Photoalignment Layer>

(Synthesis of Polymer C-1)

1 part by mass of 2,2′-azobis(isobutyronitrile) as a polymerization initiator and 180 parts by mass of diethylene glycol methyl ethyl ether as a solvent were introduced into a flask comprising a cooling pipe and a stirrer. 100 parts by mass of 3,4-epoxycyclohexylmethyl methacrylate was further added into the flask, the inside of the flask was replaced with nitrogen, and then the obtained mixture was stirred. The solution temperature of the mixture was elevated to 80° C., and the temperature was kept for 5 hours to obtain a polymer solution including about 35% by mass of a polymethacrylate having an epoxy group. The weight-average molecular weight Mw of the obtained polymethacrylate having an epoxy group was 25,000.

Subsequently, 286 parts by mass of a solution including the polymethacrylate having an epoxy group obtained above (100 parts by mass in terms of the polymethacrylate), 120 parts by mass of a cinnamic acid derivative obtained by the method of Synthesis Example 1 of JP2015-026050A, 20 parts by mass of tetrabutylammonium bromide as a catalyst, and 150 parts by mass of propylene glycol monomethyl ether acetate as a diluting solvent were introduced into a separate reaction vessel, and the mixture was stirred at 90° C. for 12 hours under a nitrogen atmosphere. After completion of the stirring, the mixture was diluted by the addition of 100 parts by mass of propylene glycol monomethyl ether acetate, and the obtained mixture was washed three times with water. The mixture after washing with water was poured into a large excess of methanol to precipitate the polymer, the recovered polymer was dried in vacuo at 40° C. for 12 hours to obtain the following polymer C-1 having a photoalignable group.

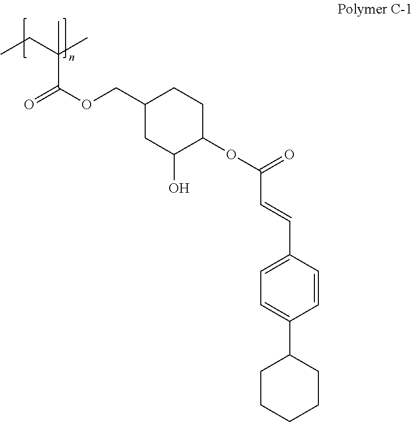

(Synthesis of Polymer C-2)

100.0 parts by mass of 2-(3,4-epoxycyclohexyl)ethyltrimethoxysilane, 500 parts by mass of methyl isobutyl ketone, and 10.0 parts by mass of triethylamine were introduced into a reaction vessel comprising a stirrer, a thermometer, a dropping funnel, and a reflux condenser, and the mixture was stirred at room temperature. Next, 100 parts by mass of deionized water was added dropwise to the obtained mixture from the dropping funnel for 30 minutes, and then the mixture was allowed to undergo a reaction at 80° C. for 6 hours while mixing the mixture under reflux. After completion of the reaction, the organic phase was extracted and washed until water after washing with a 0.2%-by-mass aqueous ammonium nitrate solution became neutral. Thereafter, the solvent and water were distilled off from the obtained organic phase under reduced pressure to obtain a polyorganosiloxane having an epoxy group as a viscous transparent liquid.

The polyorganosiloxane having an epoxy group was subjected to ¹H-NMR (Nuclear Magnetic Resonance) analysis, and it was thus found that a peak based on an oxiranyl group was obtained around a chemical shift (δ)=3.2 ppm with a theoretical strength, and a side reaction of the epoxy group did not occur during the reaction. The weight-average molecular weight Mw and the epoxy equivalents of the polyorganosiloxane having an epoxy group were 2,200 and 186 g/mol, respectively.

Next, 10.1 parts by mass of the polyorganosiloxane having an epoxy group obtained above, 0.5 parts by mass of an acryl group-containing carboxylic acid (manufactured by Toagosei Co., Ltd., trade name “Aronix M-5300”, acrylic acid ω-carboxypolycaprolactone (polymerization degree n≈2)), 20 parts by mass of butyl acetate, 1.5 parts by mass of the cinnamic acid derivative obtained by the method of Synthesis Example 1 of JP2015-026050A, and 0.3 parts by mass of tetrabutylammonium bromide were introduced into a 100-mL three-neck flask, and the obtained mixture was stirred at 90° C. for 12 hours. After stirring, the mixture was diluted with butyl acetate in the same amount (mass) as that of the obtained mixture, and the diluted mixture was washed three times with water. The obtained mixture was concentrated and twice subjected to an operation of dilution with butyl acetate, thereby finally obtaining a solution including a polyorganosiloxane containing a photoalignable group (the following polymer C-2). The weight-average molecular weight Mw of the polymer C-2 was 9,000. Further, as a result of ¹H-NMR analysis, the components having a cinnamate group in the polymer C-2 were at 23.7% by mass.

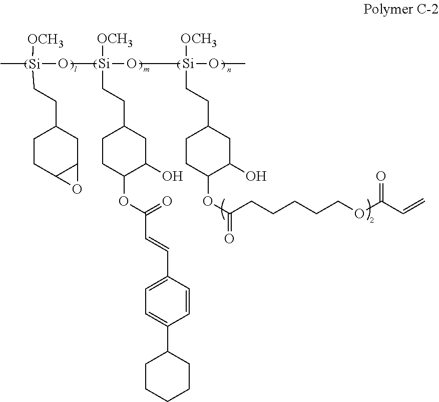

### Example 1

(Preparation of Cellulose Acetate Solution)

The composition shown in Table 2 was put into a mixing tank and stirred while heating at 30° C. to dissolve the respective components, thereby preparing a cellulose acetate solution (a dope for an inner layer and a dope for an outer layer).

TABLE 2

| | Inner layer | Outer layer |
|---|---|---|
| Composition of cellulose acetate solution | (parts by mass) | (parts by mass) |
| Cellulose acetate with degree of acetyl substitution of 2.86 | 100 | 100 |
| Triphenyl phosphate | 7.8 | 7.8 |
| (plasticizer) | | |
| Biphenyldiphenyl phosphate | 3.9 | 3.9 |
| (plasticizer) | | |
| Methylene chloride | 293 | 314 |
| (first solution) | | |
| Methanol | 71 | 76 |
| (second solution) | | |
| 1-Butanol | 1.5 | 1.6 |
| (third solution) | | |
| Silica fine particles | 0 | 0.8 |
| (AEROSIL R972, manufactured by Nippon Aerosil Co., Ltd.) | | |
| Retardation enhancer represented by General Formula (2) | 1.7 | 0 |

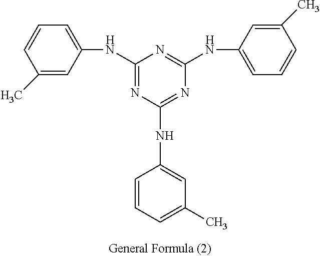

(Manufacture of Cellulose Acetate Film)

The dope for an inner layer and the dope for an outer layer obtained above were cast on a drum which had been cooled to 0° C. using from a three-layer co-casting die.

The film having an amount of the residual solvent of 70% by mass was peeled from the drum, both the ends of the peeled film were fixed with a pin tenter, and the film was dried at 80° C. while transporting the film at a draw ratio of 110% in the transporting direction, and dried at 110° C. at a time of the amount of the residual solvent of the film reaching 10%.

Thereafter, the film was dried at a temperature of 140° C. for 30 minutes to manufacture a cellulose acetate film S-1 (outer layer: 3 μm, the inner layer: 34 μm, outer layer: 3 μm) having an amount of the residual solvent of 0.3% by mass. Further, the thickness of the cellulose acetate film S-1 was 40 μm. Incidentally, the Re and the Rth of the cellulose acetate film S-1 were 5 nm and 40 nm, respectively. In addition, the tensile elastic modulus of the cellulose acetate film S-1 was 4.0 GPa.

The cellulose acetate film S-1 thus manufactured was immersed for 2 minutes in a 2.0 N aqueous potassium hydroxide solution (25° C.), then neutralized with sulfuric acid, washed with pure water, and dried to obtain a support. A surface energy of the obtained support was determined by a contact angle method and found to be 63 mN/m.

(Manufacture of Alignment Layer)

The composition 1 for forming an alignment layer having the following composition was applied onto the support (alkali-treated surface) at 28 mL/m² with a #16 wire bar coater.

Thereafter, the support having the composition 1 for forming an alignment layer applied thereon was dried with hot air at 60° C. for 60 seconds and further dried with hot air at 90° C. for 150 seconds to manufacture a coating film on the support.

(Composition 1 for Forming Alignment Layer)

The following components were mixed to prepare a composition 1 for forming an alignment layer.
Modified polyvinyl alcohol represented by General Formula (D-1) . . . 10 parts by mass
Water . . . 371 parts by mass
Methanol . . . 119 parts by mass
Glutaraldehyde (crosslinking agent) . . . 0.5 parts by mass
Citric acid ester (AS3 manufactured by Sankyo Chemical Co., Ltd.) . . . 0.175 parts by mass
Photopolymerization initiator (Irgacure 2959 manufactured by Ciba Specialty Chemicals Inc.) . . . 2.0 parts by mass

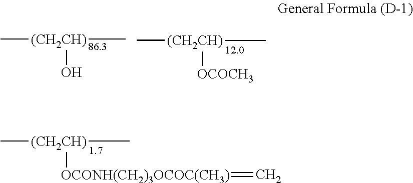

Subsequently, the coating film was subjected to a rubbing treatment along a direction parallel to the slow axis of the support (measured at a wavelength of 632.8 nm) to manufacture an alignment layer (alignment layer D-1).

(Preparation of Polymerizable Liquid Crystal Composition 1)

The following components were mixed to prepare a polymerizable liquid crystal composition 1.
Compound (A-1) . . . 100.00 parts by mass
Additive (B-1) . . . 0.53 parts by mass
Polymerization initiator S-1 . . . 3.00 parts by mass
Leveling agent (the following compound T-1) . . . 0.20 parts by mass
Methyl ethyl ketone . . . 219.30 parts by mass

Additive (B-1) (Refer to the Following Structural Formulae)

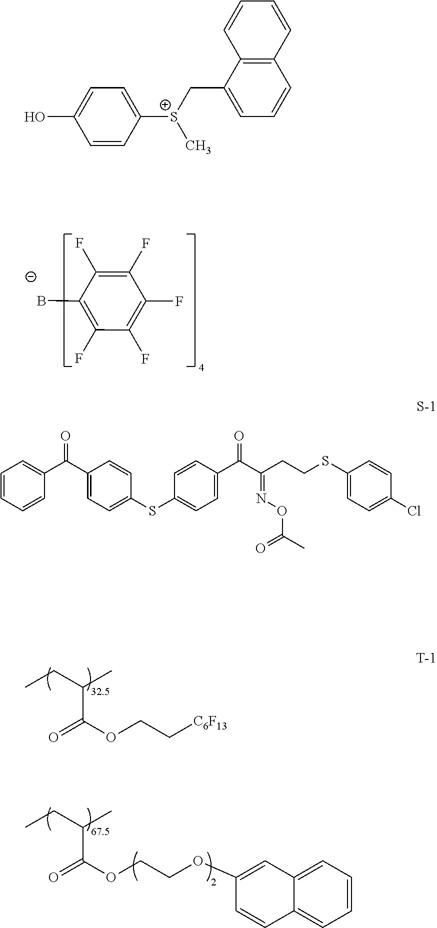

(Manufacture of Optical Film 1)

The polymerizable liquid crystal composition 1 was applied onto the alignment layer (D-1) by a spin coating method to form a liquid crystal composition layer 1.

The formed liquid crystal composition layer 1 was heated once on a hot plate to an isotropic phase and then kept at 60° C., and the liquid crystal composition layer 1 was subjected to irradiation with ultraviolet rays (500 mJ/cm², using an ultra-high pressure mercury lamp) in a nitrogen atmosphere (at an oxygen concentration of 100 ppm) to fix the alignment of the liquid crystal compound, whereby a retardation layer having a thickness of 2.0 μm was formed and an optical film 1 was thus obtained.

Incidentally, the additive was cleaved during heating (B-1) and thus, an acid was generated.

### Example 2

(Preparation of Composition 2 for Forming Alignment Layer)

The following components were mixed to prepare a composition 2 for forming an alignment layer.
Polymer C-1 . . . 10.67 parts by mass
Low-molecular-weight compound R-1 . . . 5.17 parts by mass
Additive (B-1) . . . 0.53 parts by mass
Butyl acetate . . . 8,287.37 parts by mass
Propylene glycol monomethyl ether acetate . . . 2,071.85 parts by mass

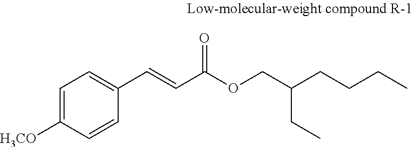 [SMILES: CCCCC(CC)COC(=O)/C=C/c1ccc(OC)cc1]

(Preparation of Polymerizable Liquid Crystal Composition 2)

The following components were mixed to prepare a polymerizable liquid crystal composition 2.
Compound A-1 . . . 100.00 parts by mass
Polymerization initiator S-1 . . . 3.00 parts by mass
Leveling agent (compound T-1) . . . 0.20 parts by mass
Methyl ethyl ketone . . . 219.30 parts by mass

(Manufacture of Optical Film 2)

Using cellulose acetate film S-1 which had not been subjected to a saponification treatment as a support, the composition 2 for forming an alignment layer was applied onto the support by a spin coating method, and the support having the composition 2 for forming an alignment layer applied thereon was dried on a hot plate at 80° C. for 5 minutes to remove the solvent to form a coating film. Incidentally, the additive (B-1) was cleaved during heating, and thus, an acid was generated.

The obtained coating film was irradiated with polarized ultraviolet rays (20 mJ/cm², using an ultra-high pressure mercury lamp) to manufacture an alignment layer (corresponding to a so-called photoalignment layer).

Next, the polymerizable liquid crystal composition 2 was applied onto the obtained alignment layer by a spin coating method, and the support having the polymerizable liquid crystal composition 2 applied thereon was heated once on a hot plate to an isotropic phase and then cooled to 60° C. to stabilize the alignment of the liquid crystal compound.

Thereafter, while keeping the temperature at 60° C., the coating film was subjected to irradiation with ultraviolet rays (500 mJ/cm², using an ultra-high pressure mercury lamp) in a nitrogen atmosphere (at an oxygen concentration of 100 ppm) to fix the alignment of the liquid crystal compound, whereby a retardation layer having a thickness of 2.0 m was formed and an optical film 2 was obtained.

### Examples 3, 5, 7, 9, 11, 13, 15, 17, 19, 21, 23, 25, 27, 29, and 31

An optical film was obtained in accordance with the same procedure as in Example 1, except that the types of the liquid crystal compounds as well as the amounts of the additives to be used and the types of the additives were changed to the types in Table 3 and Table 3-2.

Incidentally, in Examples 1, 3, 5, 7, 9, 11, 13, and 15, the amounts of the additives to be used were adjusted to 0.67% by mole with respect to the liquid crystal compound, and in Examples 17, 19, 21, 23, 25, 27, 29, and 31, the amounts of the additives to be used were adjusted to 2.01% by mole with respect to the liquid crystal compound.

### Examples 4, 6, 8, 10, 12, 14, 16, 18, 20, 22, 24, 26, 28, and 30

An optical film was obtained in accordance with the same procedure as in Example 2, except that the types of the liquid crystal compounds and the polymers for a photoalignment layer as well as the amounts of the additives to be used and the types of the additives were changed to the types in Table 3 and Table 3-2.

Incidentally, in Examples 4, 6, 8, 10, 12, 14, 16, 18, 20, 22, 24, 26, 28, and 30, the amounts of the additives to be used were adjusted to 0.67% by mole with respect to the liquid crystal compound.

In addition, the additives (B-2) to (B-6) described in Table 3 and Table 3-2 are as follows. Incidentally, any of the additives (B-1) to (B-4), and (B-6) correspond to thermal acid generators.

Additives (B-2): SAN AID SI-300 manufactured by Sanshin Chemical Industry Co., Ltd. (the following structural formula).

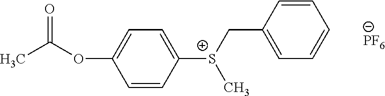

Additives (B-3): SAN AID SI-360 manufactured by Sanshin Chemical Industry Co., Ltd. was synthesized by salt exchange in F Top EF-N302 manufactured by Mitsubishi Materials Electronic Chemicals Co., Ltd. and methanol (the following structural formula).

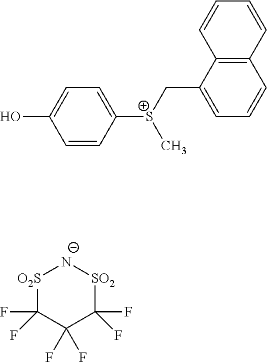 [SMILES: C[S+](Cc1cccc2ccccc12)c1ccc(O)cc1 ; O=S1(=O)[N-]S(=O)(=O)C(F)(F)C(F)(F)C1(F)F]

Additive (B-4): SAN AID SI-60 manufactured by Sanshin Chemical Industry Co., Ltd. (the following structural formula)

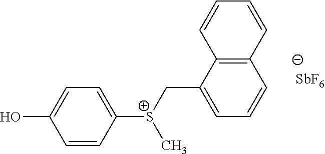

Additive (B-5); Manufactured by Wako Pure Chemical Industries, Ltd. (the following structural formula)

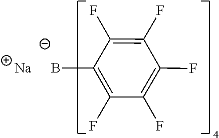

Additive (B-6): SAN AID SI-360 manufactured by Sanshin Chemical Industry Co., Ltd. was synthesized by salt exchange in trifluoromethanesulfonic acid and methanol (the following structural formula).

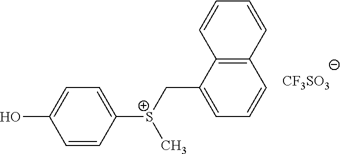

In Table 3, an expression, “pKa of core”, is intended to mean the pKa of a compound represented by HO—Ar—OH including the same structure as a partial structure corresponding to —O—Ar—O— of each of the liquid crystal compounds.

In Table 3, an expression, “Addition amount vs. liquid crystal”, is intended to mean the amount (% by mole) of an acid generated from an additive with respect to a liquid crystal compound.

In Table 3, an expression, “pKa of conjugate acid of additive”, is intended to mean the pKa of an acid generated from an additive.

In Table 3, an expression, “PVA (D-1)”, is intended to mean “modified polyvinyl alcohol represented by General Formula (D-1)”.

<Evaluation of Wet Heat Resistance>

The optical film manufactured in each of Examples and Comparative Examples was left to stand in an environment at a temperature of 65° C. and a humidity of 90% for 500 hours, and the in-plane retardation Re of the optical film before being left to stand in a wet heat environment (initial Re1) and the in-plane retardation Re of the optical film after being left to stand in a wet heat environment (Re1 after standing) were compared to each other to calculate a Re change rate 1.

Furthermore, the Re change rate 1 is calculated by the following equation.

Re change rate 1(%)={(Initial Re1−Re1 after standing)/Initial Re1}×100

Furthermore, a comparative optical film was manufactured without use of an additive of each of Examples and Comparative Examples, and according to the same procedure as above, the in-plane retardation Re of the comparative optical film before being left to stand in a wet heat environment (initial Re2) and the in-plane retardation Re of the comparative optical film after being left to stand in a wet heat environment (Re2 after standing) were compared to each other to calculate a Re change rate 2.

Furthermore, the Re change rate 2 is calculated by the following equation.

Re change rate 2(%)={(Initial Re2−Re2 after standing)/Initial Re2}×100

A difference between the Re change rate 2 and the Re change rate 1 (Re change rate 2-Re change rate 1) was evaluated according to the following standard. As the difference is greater, suppression of a change in the retardation is intended.

A: The difference is 20% or more.

B: The difference is 10% or more and less than 20%.

C: The difference is less than 10%.

In addition, the initial Re1, the Re1 after standing, the initial Re2, and the Re2 after standing are retardations at a wavelength of 550 nm.

A presence of the specific acid or a salt thereof in the retardation layer or the alignment layer in the optical film manufactured in each of Examples was confirmed by time-of-flight secondary ion mass spectrometry (TOF-SIMS).

TABLE 3

| | | | Retardation layer | | |
|---|---|---|---|---|---|
| | Alignment layer | | Type of liquid crystal | pKa (A) of | Additive |
| | Name | Type of polymer | compound | core | Type |
| Example 1 | Alignment film D-1 | PVA (D-1) | Compound A-1 | 8.30 | Additive B-1 |
| Example 2 | Photoalignment film C-1 | Polymer C-1 | Compound A-1 | 8.30 | Additive B-1 |
| Example 3 | Alignment film D-1 | PVA (D-1) | Compound A-1 | 8.30 | Additive B-2 |
| Example 4 | Photoalignment film C-1 | Polymer C-1 | Compound A-1 | 8.30 | Additive B-2 |
| Example 5 | Alignment film D-1 | PVA (D-1) | Compound A-2 | 8.47 | Additive B-1 |
| Example 6 | Photoalignment film C-1 | Polymer C-1 | Compound A-2 | 8.47 | Additive B-1 |
| Example 7 | Alignment film D-1 | PVA (D-1) | Compound A-2 | 8.47 | Additive B-3 |
| Example 8 | Photoalignment film C-1 | Polymer C-1 | Compound A-2 | 8.47 | Additive B-3 |
| Example 9 | Alignment film D-1 | PVA (D-1) | Compound A-3 | 8.82 | Additive B-1 |
| Example 10 | Photoalignment film C-1 | Polymer C-1 | Compound A-3 | 8.82 | Additive B-1 |
| Example 11 | Alignment film D-1 | PVA (D-1) | Compound A-3 | 8.82 | Additive B-4 |
| Example 12 | Photoalignment film C-1 | Polymer C-1 | Compound A-3 | 8.82 | Additive B-4 |
| Example 13 | Alignment film D-1 | PVA (D-1) | Compound A-4 | 9.56 | Additive B-1 |
| Example 14 | Photoalignment film C-1 | Polymer C-1 | Compound A-4 | 9.56 | Additive B-1 |
| Example 15 | Alignment film D-1 | PVA (D-1) | Compound A-4 | 9.56 | Additive B-5 |
| Example 16 | Photoalignment film C-1 | Polymer C-1 | Compound A-4 | 9.56 | Additive B-5 |
| Example 17 | Alignment film D-1 | PVA (D-1) | Compound A-1 | 8.30 | Additive B-1 |
| Example 18 | Photoalignment film C-2 | Polymer C-2 | Compound A-1 | 8.30 | Additive B-1 |
| Example 19 | Alignment film D-1 | PVA (D-1) | Compound A-1 | 8.30 | Additive B-2 |
| Example 20 | Photoalignment film C-2 | Polymer C-2 | Compound A-1 | 8.30 | Additive B-2 |

| | Additive | | | | |
|---|---|---|---|---|---|
| | pKa (B) of | | Addition amount vs. | Relational | |
| | conjugate acid of | | liquid crystal | formula | Wet heat |
| | additive | Additive layer | mol (%) | (A) − (B) | resistance |
| Example 1 | −13.5 | Liquid crystal layer | 0.67 | 21.80 | A |
| Example 2 | −13.5 | Photoalignment film layer | 0.67 | 21.80 | A |
| Example 3 | −12.0 | Liquid crystal layer | 0.67 | 20.30 | B |
| Example 4 | −12.0 | Photoalignment film layer | 0.67 | 20.30 | B |
| Example 5 | −13.5 | Liquid crystal layer | 0.67 | 21.97 | A |
| Example 6 | −13.5 | Photoalignment film layer | 0.67 | 21.97 | A |
| Example 7 | −11.6 | Liquid crystal layer | 0.67 | 20.02 | B |
| Example 8 | −11.6 | Photoalignment film layer | 0.67 | 20.02 | B |
| Example 9 | −13.5 | Liquid crystal layer | 0.67 | 22.32 | A |
| Example 10 | −13.5 | Photoalignment film layer | 0.67 | 22.32 | A |
| Example 11 | −14.9 | Liquid crystal layer | 0.67 | 23.72 | A |
| Example 12 | −14.9 | Photoalignment film layer | 0.67 | 23.72 | A |
| Example 13 | −13.5 | Liquid crystal layer | 0.67 | 23.06 | A |
| Example 14 | −13.5 | Photoalignment film layer | 0.67 | 23.06 | A |
| Example 15 | −13.5 | Liquid crystal layer | 0.67 | 23.06 | A |
| Example 16 | −13.5 | Photoalignment film layer | 0.67 | 23.06 | A |
| Example 17 | −13.5 | Liquid crystal layer | 2.01 | 21.80 | A |
| Example 18 | −13.5 | Photoalignment film layer | 0.67 | 21.80 | A |
| Example 19 | −12.0 | Liquid crystal layer | 2.01 | 20.30 | B |
| Example 20 | −12.0 | Photoalignment film layer | 0.67 | 20.30 | B |

TABLE 3-2

| | | | Retardation layer | | |
|---|---|---|---|---|---|
| | Alignment layer | | Type of liquid crystal | pKa (A) of | Additive |
| | Name | Type of polymer | compound | core | Type |
| Example 21 | Alignment film D-1 | PVA (D-1) | Compound A-2 | 8.47 | Additive B-1 |
| Example 22 | Photoalignment film C-2 | Polymer C-2 | Compound A-2 | 8.47 | Additive B-1 |
| Example 23 | Alignment film D-1 | PVA (D-1) | Compound A-2 | 8.47 | Additive B-3 |
| Example 24 | Photoalignment film C-2 | Polymer C-2 | Compound A-2 | 8.47 | Additive B-3 |
| Example 25 | Alignment film D-1 | PVA (D-1) | Compound A-3 | 8.82 | Additive B-1 |
| Example 26 | Photoalignment film C-2 | Polymer C-2 | Compound A-3 | 8.82 | Additive B-1 |
| Example 27 | Alignment film D-1 | PVA (D-1) | Compound A-3 | 8.82 | Additive B-4 |
| Example 28 | Photoalignment film C-2 | Polymer C-2 | Compound A-3 | 8.82 | Additive B-4 |
| Example 29 | Alignment film D-1 | PVA (D-1) | Compound A-4 | 9.56 | Additive B-1 |
| Example 30 | Photoalignment film C-2 | Polymer C-2 | Compound A-4 | 9.56 | Additive B-1 |
| Example 31 | Alignment film D-1 | PVA (D-1) | Compound A-4 | 9.56 | Additive B-5 |
| Comparative | Photoalignment film C-1 | Polymer C-1 | Compound A-2 | 8.47 | Additive B-6 |
| Example 1 | | | | | |
| Comparative | Photoalignment film C-1 | Polymer C-1 | Compound A-3 | 8.82 | Additive B-6 |
| Example 2 | | | | | |
| Comparative | Photoalignment film C-1 | Polymer C-1 | Compound A-4 | 9.56 | Additive B-6 |
| Example 3 | | | | | |

| | Additive | | | | |
|---|---|---|---|---|---|
| | pKa (B) of | | Addition amount vs. | Relational | |
| | conjugate acid of | | liquid crystal | formula | Wet heat |
| | additive | Additive layer | mol (%) | (A) − (B) | resistance |
| Example 21 | −13.5 | Liquid crystal layer | 2.01 | 21.97 | A |
| Example 22 | −13.5 | Photoalignment film layer | 0.67 | 21.97 | A |
| Example 23 | −11.6 | Liquid crystal layer | 2.01 | 20.02 | B |
| Example 24 | −11.6 | Photoalignment film layer | 0.67 | 20.02 | B |
| Example 25 | −13.5 | Liquid crystal layer | 2.01 | 22.32 | A |
| Example 26 | −13.5 | Photoalignment film layer | 0.67 | 22.32 | A |
| Example 27 | −14.9 | Liquid crystal layer | 2.01 | 23.72 | A |
| Example 28 | −14.9 | Photoalignment film layer | 0.67 | 23.72 | A |
| Example 29 | −13.5 | Liquid crystal layer | 2.01 | 23.06 | A |
| Example 30 | −13.5 | Photoalignment film layer | 0.67 | 23.06 | A |
| Example 31 | −13.5 | Liquid crystal layer | 2.01 | 23.06 | A |
| Comparative | −3.6 | Photoalignment film layer | 0.67 | 12.07 | C |
| Example 1 | | | | | |
| Comparative | −3.6 | Photoalignment film layer | 0.67 | 12.42 | C |
| Example 2 | | | | | |
| Comparative | −3.6 | Photoalignment film layer | 0.67 | 13.16 | C |
| Example 3 | | | | | |

As seen from Table 3 and Table 3-2, it was confirmed that the wet heat resistance was excellent with the optical film of the embodiment of the present invention.

Above all, it was confirmed that in a case where (A)-(B) is 21.0 or more, the effects are more excellent.

Furthermore, it was confirmed that even in a case where HB(C₆F₅)₄ was used instead of the additive B-1 of Example 1, the same extent of effects as in Example 1 occurs.

In addition, even in a case where the amount of the additive to be used was adjusted to 2.01% by mole with respect to the liquid crystal compound in each of Examples 2 and 18, the same good results as that with 0.67% by mole was obtained.

### EXPLANATION OF REFERENCES

10A, 10B optical film
12 alignment layer
14 retardation layer
16 support

What is claimed is:

1. An optical film comprising:
an alignment layer; and
a retardation layer which is disposed on the alignment layer and formed using a polymerizable liquid crystal composition including a liquid crystal compound represented by Formula (I),
wherein at least one of an acid having the pKa of −10.0 or less or a salt of the acid is included in at least one of the alignment layer or the retardation layer,
L¹-SP¹-A¹-D³-G-D-Ar-D²-G²-D⁴-A²-SP²-L² Formula (I)
in Formula (I), D¹, D², D³, and D⁴ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—, provided that at least one of D¹, D², D³, or D⁴ represents —O—CO—,
R¹, R², R³, and R⁴ each independently represent a hydrogen atom, a fluorine atom, or an alkyl group having 1 to 4 carbon atoms,
G¹ and G² each independently represent a divalent alicyclic hydrocarbon group having 5 to 8 carbon atoms which may have a substituent, and one or more of —CH₂-'s constituting the alicyclic hydrocarbon group may be substituted with —O—, —S—, or —NH—,
A¹ and A² each independently represent a single bond, an aromatic ring having 6 or more carbon atoms, or a cycloalkylene ring having 6 or more carbon atoms,
SP¹ and SP² each independently represent a single bond, a linear or branched alkylene group having 1 to 14 carbon atoms, or a divalent linking group in which one or more of —CH₂-'s constituting the linear or branched alkylene group having 1 to 14 carbon atoms are substituted with —O—, —S—, —NH—, —N(Q)-, or —CO—, and Q represents a polymerizable group,
L¹ and L² each independently represent a monovalent organic group, and at least one of L¹ or L² represents a polymerizable group, and
Ar represents any one aromatic ring selected from the group consisting of groups represented by Formulae (Ar-1) to (Ar-5), 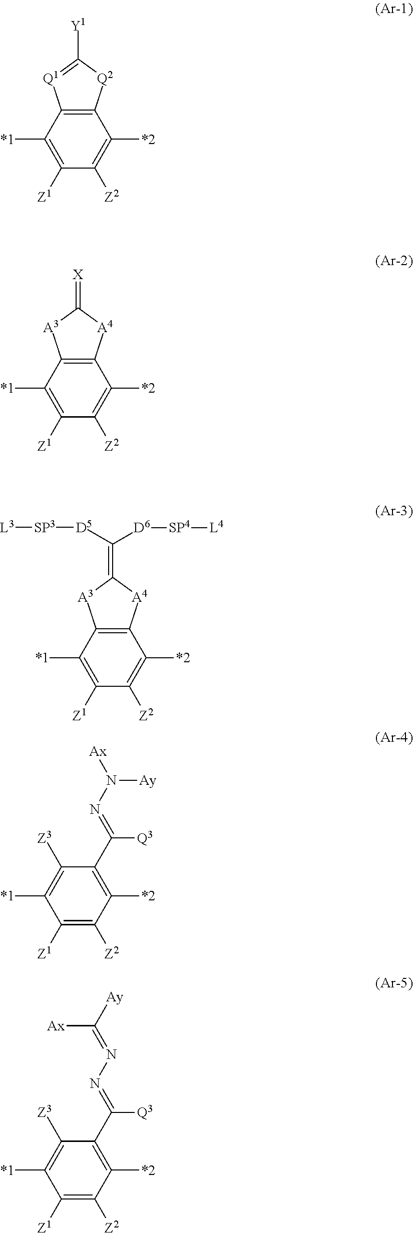
in Formulae (Ar-1) to (Ar-5), *1 represents a bonding position to D¹ and *2 represents a bonding position to D²,
Q¹ represents N or CH,
Q² represents —S—, —O—, or —N(R⁵)—, and R⁵ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —NR⁶R⁷, or —SR⁸, R⁶ to R⁸ each independently represent a hydrogen atom or an alkyl group having 1 to 6 carbon atoms, and Z¹ and Z² may be bonded to each other to form a ring,
A³ and A⁴ each independently represent a group selected from the group consisting of —O—, —N(R⁹)—, —S—, and —CO—, and R⁹ represents a hydrogen atom or a substituent,
X represents a hydrogen atom or a non-metal atom of Groups 14 to 16 to which a substituent may be bonded,
D⁵ and D⁶ each independently represent a single bond, —O—CO—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—, and R¹, R², R³, and R⁴ each independently represent a hydrogen atom, a fluorine atom, or an alkyl group having 1 to 4 carbon atoms,
SP³ and SP⁴ each independently represent a single bond, a linear or branched alkylene group having 1 to 12 carbon atoms, or a divalent linking group in which one or more of —CH₂-'s constituting the linear or branched alkylene group having 1 to 12 carbon atoms are substituted with —O—, —S—, —NH—, —N(Q)-, or —CO—, and Q represents a polymerizable group,
L³ and L⁴ each independently represent a monovalent organic group, and at least one of L³, L⁴, or L¹ or L² in Formula (I) represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 6 carbon atoms which may have a substituent, or an organic group having 2 to 30 carbon atoms, which has at least one aromatic ring selected from the group consisting of an aromatic hydrocarbon ring and an aromatic heterocyclic ring,
the aromatic rings in each of Ax and Ay may have a substituent, and Ax and Ay may be bonded to each other to form a ring, and
Q³ represents a hydrogen atom or an alkyl group having 1 to 6 carbon atoms which may have a substituent.

2. The optical film according to claim 1,
wherein at least one of D¹ or D² is *1-O—CO—, *1-O—CR¹R²—, or *1-O—CO—CR¹R²—, and *1 represents a bonding position on the Ar side.

3. The optical film according to claim 2,
wherein in a case where D¹ is *1-O—CO—, *1-O—CR¹R²—, or *1-O—CO—CR¹R²—, a difference between the pKa of a compound represented by Formula (III) having the same structure as a partial structure represented by —O—Ar-D²-G²-D⁴-A²-SP²-L² in Formula (I) and the pKa of the acid is 18.0 or more.
HO—Ar-D²-G²-D⁴-A²-SP²-L² Formula (III)

4. The optical film according to claim 2,
wherein in a case where both of D¹ and D² are *1-O—CO—, *1-O—CR¹R²—, or *1-O—CO—CR¹R²—, a difference between the pKa of a compound represented by Formula (II) having the same structure of a partial structure represented by —O—Ar—O— in Formula (I) and the pKa of the acid is 18.0 or more.
HO—Ar—OH Formula (II)

5. The optical film according to claim 3,
wherein the difference between the pKa of the compound represented by Formula (III) and the pKa of the acid is 21.0 or more.

6. The optical film according to claim 4,
wherein the difference between the pKa of the compound represented by Formula (II) and the pKa of the acid is 21.0 or more.

7. The optical film according to claim 3,
wherein the pKa of the compound represented by Formula (III) is 8.0 or more.

8. The optical film according to claim 7,
wherein the pKa of the compound represented by Formula (III) is 8.3 or more.

9. The optical film according to claim 4,
wherein the pKa of the compound represented by Formula (II) is 8.0 or more.

10. The optical film according to claim 9,
wherein the pKa of the compound represented by Formula (II) is 8.3 or more.

11. The optical film according to claim 1,
wherein at least one of the acid or a salt of the acid is included in the alignment layer, and
a total content of the acid and the salt of the acid in the alignment layer is 0.10% to 5.00% by mole with respect to the liquid crystal compound represented by Formula (I).

12. The optical film according to claim 1,
wherein at least one of the acid or a salt of the acid is included in the retardation layer, and
a total content of the acid and the salt of the acid in the retardation layer is 0.10% to 5.00% by mole with respect to the liquid crystal compound represented by Formula (I).

13. A polarizing plate comprising:
the optical film according to claim 1; and
a polarizer.

14. An image display device comprising the optical film according to claim 1.

15. An image display device comprising the polarizing plate according to claim 13.

16. A method for producing the optical film according to claim 1, comprising:
applying a composition for forming an alignment layer, including a thermal acid generator that generates an acid having the pKa of −10.0 or less and a compound having a photoalignable group to form a coating film, subjecting the coating film to a heating treatment, and subjecting the coating film which has been subjected to the heating treatment to a photoalignment treatment to obtain the alignment layer; and
applying the polymerizable liquid crystal composition onto the alignment layer to form a coating film, subjecting the coating film to a heating treatment to align the liquid crystal compound, and subjecting the coating film to a curing treatment to obtain the retardation layer.

17. A method for producing the optical film according to claim 1, comprising:
applying a polymerizable liquid crystal composition including the liquid crystal compound represented by Formula (I) and a thermal acid generator that generates an acid having the pKa of −10.0 or less onto an alignment layer to form a coating film, subjecting the coating film to a heating treatment to align the liquid crystal compound, and subjecting the coating film to a curing treatment to obtain the retardation layer.
